(19) United States
(12) Patent Application Publication
(10) Pub. No.: US 2021/0271012 A1
(43) Pub. Date: Sep. 2, 2021

(54) SPATIALLY VARYING VOLUME HOLOGRAPHIC GRATINGS

(71) Applicant: METACONTINENTAL INC., Dartmouth (CA)

(72) Inventors: Stefan Trotzky, Dartmouth (CA); Chris Anthony, Dartmouth (CA); Martin Bitter, Dartmouth (CA); Matthew Hickey, Dartmouth (CA); Efthymios Kallos, Dartmouth (CA); Sepideh Khosravi, Dartmouth (CA); Larisa Koskowich, Dartmouth (CA); Brandon Sumarah, Dartmouth (CA); Michael Wenyon, Dartmouth (CA)

(21) Appl. No.: 17/255,297

(22) PCT Filed: Jun. 20, 2019
(86) PCT No.: PCT/EP2019/066418

§ 371 Date: Dec. 22, 2020

(30) Foreign Application Priority Data
Jun. 22, 2018 (GB) 1810274.9

(51) Int. Cl. G02B 5/32; G03H 1/02; G02B 5/18

(52) U.S. Cl. CPC G02B 5/32; G02B 5/1847; G03H 1/0248

(57) ABSTRACT

Disclosed herein is an optical device having a spatially-varying volume holographic grating (VHG), and methods, systems and apparatus for making the same. An optical device according to the disclosure has one or both of a spacing and a slant angle of the VHG which varies across locations of the optical device. A method for making an such an optical device includes: irradiating a photosensitive material with a first beam of light; producing a volume holographic grating in the photosensitive material by producing an interference pattern between the first beam with a second beam of light; moving the first beam and the second beam or the photosensitive material relative to the other to scan the first beam and the second beam across locations on the photosensitive material; and varying one or both of a spacing and a slant angle of the volume holographic grating across locations on the photosensitive material.

### CROSS-REFERENCE TO RELATED APPLICATIONS

This application is a U.S. National Stage entry of International Patent Application no. PCT/EP2019/066418, filed Jun. 20, 2019, which claims the benefit of priority of United Kingdom Patent Application no. 1810274.9, filed Jun. 22, 2018.

### FIELD

The present disclosure relates to optical devices, such as optical filters, containing a Volume Holographic Grating (VHG) and methods and apparatus for producing the same.

### BACKGROUND

Volume Holographic Gratings (VHGs), also known as volume Bragg gratings, are periodic patterns created inside a medium. For example, the periodic patterns may be variations in the refractive index of the medium. The periodic patterns cause reflection or refraction of incident light when satisfying certain criteria for wavelength and angle of incidence. VHGs differ from diffraction gratings made on the surface of an optical medium, since the periodic pattern is disposed throughout the bulk (i.e. volume) of the medium, rather than along its surface. VHGs can be used in various kinds of optical devices for light manipulation.

VHGs are typically made by irradiating a photosensitive material with two near-monochromatic light beams with different propagation directions. The beams superimpose inside the material to produce an interference pattern, i.e. a pattern of varying intensity through the thickness of the medium. The exposure of the photosensitive material with this interference pattern creates a refractive index pattern with fundamental similarity to the intensity pattern inside the material.

The inventors have developed a technique for producing VHGs with improved scalability, disclosed in the published UK application GB2552551. The technique involves scanning a laser across a photosensitive polymer film to create a VHG in the film which blocks certain wavelengths of light at specific angles. GB2552551 discloses methods for manufacturing films comprising VHGs for use in filters which can block specific angle and wavelength ranges. The films can then be stacked to create a device which blocks multiple wavelengths or multiple angles.

### SUMMARY

According to a first aspect herein, a method for making an optical device having a spatially-varying volume holographic grating (VHG) comprises irradiating a photosensitive material with a first beam of light, e.g. from a laser, to produce the VHG in the photosensitive material. The photosensitive material can be any material which responds to varying intensity of light to produce a change in refractive index in the material. The VHG is produced due to an interference pattern in the photosensitive material resulting from interference of the first beam with a second beam. To produce the interference pattern, the two beams are at an angle to one other and are arranged to enable interference between the two beams. For example, the two beams are both sufficiently, partially, or even substantially, coherent, i.e. have a sufficiently long coherence length (or coherence time) to interfere with each other.

The VHG produced by the interference pattern can be described as comprising periodic grating features spaced along a grating direction by a spacing. The periodic grating features are a repeating pattern of refractive index. For example, an individual grating feature may be a local increase, or alternatively a local decrease, in refractive index which is repeated across the photosensitive material. The local changes in refractive index are typically gradual transitions between relatively lower refractive index regions to relatively higher refractive index regions, or vice versa. However, the local changes may take the form of a steep transition or a step change. As an example, the periodic grating features may be a sinusoidally shaped repeating pattern of refractive index (varying along the grating direction according to a sine function). Periodic patterns beyond the simple sinusoidal form are also possible. Typically, the periodic pattern repeats in only one direction, i.e. the periodic pattern can be descried or approximated by a series of planes of locally increased refractive index. The repeating pattern repeats multiple times across the photosensitive material in the grating direction. The spacing of the grating features can be defined as the distance between adjacent local increases in refractive index or, in other words, the period of the periodic pattern in the grating direction. In practice, the average spacing across a number of periods can also be used as an approximate value for the spacing and the term spacing will be understood accordingly by the reader. The period of the periodic pattern represents the length in the grating direction over which the profile of refractive index repeats itself. For a repeating pattern comprising a series of planes of locally increased refractive index, the grating direction can be defined as the direction normal to the planes of locally increased refractive index.

The grating direction forms a slant angle with respect to a surface of the photosensitive material. The slant angle can be defined as the angle between the grating direction and a line normal to the surface of the photosensitive material. Hence if the VHG has a slant angle of zero degrees the grating direction is normal to the surface of the photosensitive material and the grating features (or grating planes) repeat in a direction perpendicular to the surface of the photosensitive material. In the case of a repeating pattern comprising a series of planes of locally increased refractive index, having a slant angle of zero degrees means the planes are parallel to the surface of the photosensitive material. If the VHG has a non-zero slant angle, there is a non-zero angle between the normal of the surface of the photosensitive material and the grating direction. Accordingly, the direction of the periodic repeating of the refractive index profile, and likewise the direction in which the spacing between grating features is defined, is slanted. Hence the planes of local increase in refractive index are slanted with respect to the plane of the surface of the photosensitive material. The slant angle may take any suitable value depending on the desired application.

Together, the spacing and slant angle define the characteristics of the VHG. In theory the spacing can take any value less than the thickness of the photosensitive material in the grating direction, although in practice multiple repeat patterns are used across the thickness. The slant angle ranges from zero degrees (grating direction is parallel to the normal of surface of the photosensitive material) up to 90 degrees, with the grating direction approaching running parallel the surface of the photosensitive material at 90 degrees. The spacing and slant angle can be defined at a single point on the photosensitive material, or over a local region of the photosensitive material. In other words, the VHG can be described by defining the spacing and slant angle at each location across the photosensitive material. By convention, the spacing and slant angle of the VHG at a location can be defined to be the spacing and slant angle of the VHG in a region around that location, or an average of the values in the region. For example, the spacing and slant angle may be defined over a region having substantially constant spacing and slant angle. The values of either the spacing or slant angle of the VHG may be substantially constant across the photosensitive material while the other has different values at different locations of the photosensitive material. Equally, both spacing and slant angle may vary at different locations. In other words, the spacing and/or the slant angle of the VHG may independently vary across locations of the photosensitive material.

The photosensitive material may be any rigid or flexible layer of material that locally changes refractive index upon exposure to radiation and has a suitable thickness for the application at hand. Examples of the photosensitive material are a film, a plate or a gel.

The method further comprises moving the first beam and the second beam or the photosensitive material relative to the other to scan the first beam and second beam across locations on the photosensitive material. In this way, individual regions of the photosensitive material can be patterned separately during the method. Since the VHG is produced by a scan, a VHG can be produced with a greater extent across the photosensitive material compared to conventional methods of producing a VHG.

The method further comprises varying one or both of the spacing and the slant angle of the VHG across location of the photosensitive material. Since the spacing and/or slant angle are varied across the photosensitive material, e.g. by varying parameters of the apparatus across locations of the photosensitive material, the resulting VHG has different characteristics across the photosensitive material. In other words, a spatially-varying VHG is produced. Such VHGs have vastly increased degrees of freedom for design and, consequently, many more applications and types of implementation. For example, a single photosensitive material can be used to create a device which filters light of different wavelength and/or angle of incidence across locations on the device. This removes the need to combine multiple layers with different VHGs having different characteristics. Consequently, the number of manufacturing steps can be reduced and results in a simpler and more efficient method for making optical devices having a VHG.

The spacing and/or the slant angle of the VHG may vary gradually across locations on the photosensitive material. Gradual variation means that there are no step changes, abrupt variations, or regions in which the spacing and/or slant angle vary by a large amount across a small range of locations. For example, the variations are gradual if the spacing and/or slant angle only vary substantially over a distance on the photosensitive material greater than the wavelength of the first beam. The variation in spacing and/or slant angle should be sufficiently gradual to avoid aberrations when the optical device comprising the VHG is used at the predetermined wavelength for which it is designed. As a guide, the variation in the VHG over a distance of the wavelength of the incident beam may be less than 20% of the value of the spacing and/or slant angle. Optionally, the variation in the VHG over a distance of the wavelength of the incident beam may be less than 10% or 5% of the value of the spacing and/or slant angle.

The first beam may be an incident beam which is reflected after is passes through the photosensitive material to form a reflected beam, which is the second beam. In other words, the first beam interferes with a reflection of itself. This provides a simplified arrangement for producing the interference pattern in the photosensitive material.

The method may further comprise changing one or both of a wavelength of the first beam or second beam, or an angle of incidence of the first beam or second beam onto the photosensitive material across locations of the photosensitive material. The parameters of incident wavelength and the relative angle between the first beam and the second beam affect the produced VHG, e.g. the spacing and slant angle. For example, in the simple case of first beam and second beam being antiparallel (i.e. parallel and in opposite directions, such as the first beam being reflected off a reflector at normal incidence), the spacing between intensity maxima in the interference pattern is determined by the wavelength and the refractive index. When the first and second beams are not antiparallel but at an angle to each other, the spacing additionally depends on that angle. Changing the wavelength of first beam has the effect of varying the spacing of the VHG. The wavelength may be changed by using a tunable light source. In the case where the first beam is reflected off a static plane mirror, the angle of incidence of the first beam changing causes the angle between the first and second beams to change, and thus the fringe spacing and resulting VHG spacing are varied.

The first beam may include a further wavelength, wherein the relative beam power at the respective wavelengths (i.e. the wavelength referred to above and the “further wavelength”) is varied across locations on the photosensitive material to transition smoothly from the wavelength to the further wavelength. For example, if the first beam is produced by a laser and has controlled power, the range of parameters available for the VHG, e.g. a certain range in spacing between grating features, is determined by the available wavelengths and the range of angles possible between the first and second beams. Hence, for further values of spacing outside of the range of the laser, a second laser would be required to provide the further wavelength. Hence the first beam may comprise the first wavelength from a first light source and a second wavelength from a second light source. This increases the range of parameters available for the VHG and hence further improves the versatility of the method for producing optical devices with VHGs. Additionally, simultaneous exposure of the photosensitive material with two or more distinct wavelengths increases the number of forms of periodic patterns that can be generated to form the VHG. The relative beam power at each of the two wavelengths can be controlled by one or more optical modulators, for example with acousto-optics. Additionally, to ensure that there is not a large discontinuity in parameters of the VHG, which could cause aberrations, the relative power values for the respective wavelengths may be varied smoothly as the first beam scans the photosensitive material. The power at a particular wavelength can be defined through the power spectrum of the respective beam, e.g. as the peak value of power at that beam's wavelength, or as the integrated power in the nearby region of that wavelength. A smooth transition is understood as sufficiently continuous and without abrupt changes in value across locations of the photosensitive material in order to avoid significant aberrations or scattering etc. in the resulting device. For example, as the power at the first wavelength is decreased gradually, the power at the second wavelength is increased gradually such that ultimately, the exposure of the photosensitive material across the region of transition creates a VHG whose properties show no abrupt variations. In some embodiments, the power of one laser is smoothly decreased while the power of the other laser is smoothly increased to affect the transition. Specifically, the combined power of the first and second laser may be constant or may vary according to a defined power variation function.

The slant angle of the VHG may be varied across locations of the photosensitive material, by controlling the orientation of the interference pattern with respect to the photosensitive material. In general, the interference pattern is determined by the first and second beams, in particular the respective wavelengths and angle between the beams. The constructive interference at certain locations and destructive interference at other locations produces a spatial pattern of intensity maxima and minima. This intensity pattern can produce a refractive index change in the photosensitive material dependent on the intensity at each location. Hence the orientation of the VHG with the photosensitive material will depend on how the photosensitive material is orientated with respect to the interference pattern. For example, having the photosensitive material orientated at different angles with respect to the interference pattern will produce different slant angles.

One way of achieving different orientations of the interference pattern in the material comprises using a reflective component which reflects the first beam to form the second beam. For example, the reflective component can be a plane mirror arranged so that the first beam passes through the photosensitive material, is reflected by the plane mirror to form the second beam, wherein the second beam travels back into the photosensitive material to create an interference pattern where it overlaps with the first beam.

The slant angle of the VHG produced in the photosensitive material can be varied by controlling an orientation of a plane of reflection of the reflective component with respect to the photosensitive material. The polar slant angle of the VHG slant angle can be varied by changing the angle of the plane of reflection of the reflective component with respect to the surface of the photosensitive material. Separately or additionally, the azimuthal slant angle of the VHG can be varied by rotating the plane of reflection of the reflective component about an axis normal to the surface of the photosensitive material. The plane of reflection of a reflective component can be defined as the plane for which incident light normal to that plane is retro-reflected, i.e. reflected back along the path which it was incident along. As an example, the plane of reflection for a plane mirror is the plane of the mirror surface itself. As another example, a VHG with a constant slant angle and spacing everywhere, designed to reflect a certain wavelength, has the plane of reflection parallel to the grating planes that form the VHG, which is substantially different from the surface of the photosensitive material.

The fringes of an interference pattern resulting from interference between the first beam and the second beam reflected by the reflective component are spaced apart in the direction normal to the plane of reflection of the reflective component. Therefore, controlling the orientation of the plane of reflection of the reflective component with respect to the photosensitive material varies the slant angle of the produced VHG. This can be done as the first beam is scanned across the photosensitive material. By controlling the slant angle according to this technique, a wider variety of optical devices comprising VHGs can be produced, having spatially-varying VHGs with different slant angle values across different locations of the photosensitive material. This advantageously increases the versatility of the method and the number of potential applications for such optical devices. The method is also considerably more efficient, having fewer steps, than combining components having different slant angles.

One way to vary the slant angle across locations of the photosensitive material comprises scanning the angle of the reflective component in coordination with the scanning of the first beam. For example, the reflective component may be scanned in coordination with the scanning of the first beam such that the first beam is incident on the reflective component and reflected to form the second beam. If the first beam is translated across the surface of the photosensitive material, the reflective component can be translated in coordination with a new position of the first beam after the translation. Likewise, the reflective component can track the path of the first beam so that the reflective component reflects the first beam to form the second beam for substantially all the locations of the photosensitive material along the path of the first beam. Alternatively or additionally, the reflective component can be rotated, about an axis in the plane of reflection, during the scanning such that the slant angle is varied across locations on the photosensitive material. Alternatively or additionally, the reflective component can be rotated, about an axis normal to the plane of the photosensitive material, during the scanning such that the azimuthal slant angle is varied across locations on the photosensitive material.

In some embodiments, the rotation of the reflective element is in coordination with controlling the angle of the first beam as it irradiates the photosensitive material. For example, the angle of incidence of the first beam is coordinated so that the first beam is incident normal to the plane of reflection of the reflective component. This means the first beam is reflected to form the second beam back along the path of the first beam and is antiparallel to the first beam in the photosensitive material to produce an interference pattern. To produce a VHG with a slant angle that varies across the photosensitive material, the scanning of the first beam and its angle of incidence can be controlled in coordination with the reflective component so that at each point of the scan the first beam is retro-reflected by the reflective component (i.e. is incident normal to the plane of reflection). The reflective component and first beam both rotate, in coordination, so that the slant angle of the VHG vary across locations of the photosensitive material.

The method may include using a substantially transparent support to control the orientation of the plane of reflection of the reflective component at each scanned location of the photosensitive material. For example, the support can be placed on top of a planar mirror and have a curved or undulating top surface. When the material is placed on the support, at each location the material will have an angled orientation with respect to the reflective component. A second transparent body with a shape that is inverse to that of the support may be matched in refractive index and placed on top of the photosensitive material to compensate any focussing or de-focussing refraction of the first beam. In another example, the surface of the support which supports the material may be substantially planar and a curved or undulating reflective component is located along the opposite side of the support to the material. For example, the reflective component could be a surface of the support itself, optionally having a reflective coating. In either case, the slope of the support controls the relative orientation of the reflective component and the photosensitive material. The first beam is scanned across locations of the photosensitive material with the angle of incidence coordinated so that the first beam is retro-reflected off the reflective component. This method has the advantage of requiring few moving parts, since the reflective component is static.

Another way in which the slant angle of the VHG may be varied is by using a reflective component itself comprising a VHG which varies across the reflective component. In other words, the plane of reflection of the reflective component is different at different locations of the reflective component. Hence, even if the surface of the reflective component and the photosensitive material are substantially parallel, the plane of reflection at each location on the reflective component will be at a different orientation with respect to the photosensitive material. Accordingly, the interference pattern between the first beam and the second beam reflected off the reflective component will produce a VHG with a slant angle. This arrangement has the advantage that there are few moving parts, meaning less opportunity for error. Furthermore, the arrangement can be compact with the reflective component in contact with the photosensitive material but still able to produce a varying slant angle. Additionally, this method can improve the ease of manufacturing since the VHG in the reflective component is effectively copied into the photosensitive material. In other words, the pattern of slant angle at each location of the reflective component is then formed in the photosensitive material. Hence the reflective component can be considered a ‘master copy’ of a particular spatially-varying VHG which can then be copied quickly and easily.

The method may further comprise forming the reflective component from tiles of reflective components. For example, in the arrangement where the reflective component comprises a spatially-varying VHG, the spatially-varying VHG can be formed by using tiled reflective components. Each tile may itself have a constant or spatially-varying VHG, and/or may have a different spacing or slant angle to other tiles. The rotational orientation of the tiles will also control the azimuthal slant angle. When the tiles are combined, e.g. tiled or placed adjacently, to form the reflective component, and the above methods carried out, the result is a single photosensitive material comprising a VHG having regions corresponding to the VHGs in the tiles. This advantageously allows for smaller optical devices comprising VHGs to be combined to produce a larger optical device with a VHG having specific values for spacing and slant angle across locations on the photosensitive material. This method therefore improves the scalability of the manufacturing process, allowing VHGs of larger size (e.g. larger area) which would not be possible with other VHG manufacturing techniques.

The method may further comprise passing the first beam through a beam-diverging component to increase the divergence of the first beam before the beam is incident on the photosensitive material. This produces a smoother transition between regions having different slant angle and/or spacing. Furthermore, whether a tiled reflective component is used or not, a beam-diverging component introduces a range of angles of incidence at each location of the photosensitive material when the first beam is scanned across the photosensitive material. This results in a corresponding range of spacing, slant angle variation at each location. This results in the VHG at each location having the desired effect for an increased range of wavelengths and/or angles. Hence increasing the divergence of the first beam increases the angular bandwidth or spectral bandwidth of the VHG at each location.

In any embodiment in which the angle of incidence changes, the method may further include adjusting the power of the first beam when the angle of incidence is changed. Any change of the angle of incidence of the first beam causes the irradiated area on the photosensitive material to vary and would cause a change in the intensity per unit area for a beam of constant power. An increase of the power with increased angle of incidence may be used to compensate for this effect, e.g. to maintain a substantially constant intensity per unit area on the photosensitive material. The intensity required to develop the photosensitive material sets the minimum substantially constant intensity to be maintained.

The method may further comprise adjusting a scan path of the first beam when the angle of incidence changes, where the change in angle of incidence causes an offset of the beam's location of incidence on the photosensitive material. This offset may constitute a deviation from the desired scan path and can be compensated either by translating the light source itself or translating a mirror assembly which directs the beam onto the photosensitive material. Alternatively or additionally, the scan path of the first beam may be adjusted to maintain a substantially constant amount of energy per unit area across locations swept by the incident beam despite a change in size of the incident beam.

The method may also comprise adjusting a scan speed with which the first beam is scanned in order to control the amount of energy per unit area across locations swept by the first beam. This can be used to compensate for changes in exposure with beam spot size in a similar way as changing the power. The exposure of the photosensitive material can be controlled to vary the energy per unit area by any combination of a change in scan speed and beam power, e.g. to maintain a substantially constant energy per unit area as the angle of incidence/beam spot size changes Maintaining a substantially constant energy per unit area across locations swept by the first beam means, for example, that the scan speed is increased when the first beam spot size is increased (or the angle of incidence increases) and vice versa. Alternatively, the scan speed can be adjusted so that the amount of energy per unit area across locations swept by the first beam is above a threshold value, e.g. a value required to produce a VHG pattern in the photosensitive material.

Embodiments comprise a step of changing or adjusting the angle of incidence of the first beam. In these embodiments, the method may comprise controlling the angle of incidence of the first beam using a mirror assembly, by rotating a first mirror of the mirror assembly. For example, the first beam may be generated by a light source, e.g. a laser, and directed to the photosensitive material by one or more mirrors. A first mirror, which may be the final mirror prior to the beam impinging the photosensitive material, sets the angle of incidence onto the photosensitive material. Hence as the first mirror rotates, the angle of incidence changes. The first mirror, for example a galvanometric mirror, may rotate about an axis on a rotating mount or may be able to rotate about multiple axes.

The mirror assembly may further comprise a second, elliptical, mirror arranged to receive the beam from the first mirror. The first and second mirrors are arranged so that a change in angle of the first mirror changes the angle of incidence of the first beam but not the location of incidence of the first beam on the photosensitive material. This can be achieved by arranging the beam spot on the first mirror and the beam spot on the material at a respective one of the two focal points of the elliptic mirror. To this end, the second mirror may have a first focal point coincident with the first mirror (specifically, the beam spot on an axis of rotation on the first mirror) and the second focal point coincident with the material. As a result, the scan path of the beam spot on the material is not altered as the angle of incidence is altered, thus avoiding the need to change the scan path in concert with the angle of incidence. The result is a simplified method of manufacture since the scan path is decoupled from the angle of incidence. When the dimensions of the elliptical second mirror are large compared to the separation of the focal points, changes in the first beam's divergence due to the variation of the ellipse's curvature are small.

In addition to or instead of a mirror assembly, the angle of incidence of the first beam can be controlled by moving a gimbal coupled to a device which emits the first beam. For example, an optical fibre can transmit the first beam from a beam source or other optical component with an end of the optical fibre coupled to a gimbal mount. The gimbal mount can rotate the end of the optical fibre to control the angle of incidence of the first beam onto the photosensitive material. This arrangement has the advantage that fewer components may be required to be accurately aligned in order to transmit the first beam from the source of the first beam to the photosensitive material. Optical fibres are, in general, flexible and have good insulation from the outside environment. Furthermore, single-mode optical fibres constitute spatial-mode filters and provide a Gaussian output beam with very little to no spatial aberration. Hence the resulting method is simpler and requires less calibration and is less susceptible to perturbations.

The step of the method moving the first beam and photosensitive material relative to each other to scan the first beam may be implemented in a number of ways. For example, the scanning step may comprise moving a scanning head directing the first beam onto the photosensitive material and the photosensitive material relative to each other. For example, the scanning head may control the location where the first beam is emitted from and at what angle of incidence. The scanning head may comprise a sliding and/or rotating stage and may be mounted on a gantry. In general, the scanning head and the photosensitive material can move in any direction in two dimensions, keeping approximately constant separation between the scanning head and photosensitive material. In other words, the scanning head and photosensitive material move relative to each other in two-dimensional motion substantially parallel to the surface of the photosensitive material.

The relative motion between scanning head and photosensitive material can involve the photosensitive material being fixed in space, for example relative to a frame of reference such as shop floor, and the scanning head, scanning the first beam across the photosensitive material. Alternatively, the scanning head may be fixed and the photosensitive material moved across the path of the first beam from the scanning head. In other examples, both the scanning head and the photosensitive material are arranged to move independently. For example, the scanning head and photosensitive material may move in different directions, each parallel to the surface of the photosensitive material. Provided that the two directions are not parallel to each other, i.e. there is an angle between then, then any location on the photosensitive material can be reached by the first beam by some combination of movements in the first and second directions.

In some embodiments, moving the first beam and material relative to each other may comprise unrolling the photosensitive material from a first spool, moving the photosensitive material past the scanning head such that the first beam scans across the surface of the photosensitive material in the rolling direction, and rolling the material onto a second spool after passage across the beam. The scanning head may be arranged to move at an angle, for example perpendicular, to the rolling direction. This roll-to-roll technique allows for large areas of VHGs to be produced in photosensitive materials in a comparably compact set-up. Using a roll-to-roll technique may increase the speed and efficiency of manufacture since set-up steps such as placing the photosensitive material in the apparatus and removing it at the end may be reduced or even avoided.

In some embodiments, the scanning head directs a plurality of incident beams onto the photosensitive material and the respective angle of incidence of each incident beam is independently controlled. In these embodiments, the methods as described above also apply to each of the incident beams. For example, the second and subsequent incident beams can be reflected to form corresponding reflective beams. The plurality of incident beams and reflected beams are each moved relative to the photosensitive material and the respective pairs of beams then produce parts of the VHG in distinct parts of the photosensitive material.

In another aspect of the disclosure an optical device comprises a spatially-varying volume holographic grating. The volume holographic grating comprises periodic grating features spaced along a grating direction by a spacing and the grating direction forms a slant angle with respect to a surface of the photosensitive material, wherein the spacing and slant angle are described further above. One or both of the spacing and the slant angle of the volume holographic grating vary across locations on the optical device. Optical devices having these features provide enhanced functionality since different locations of the VHG can create different effects on incoming light and/or affect different wavelengths.

The VHG may be formed in a photosensitive material of the optical device, produced by the methods described above and further treated or ‘developed’ to make permanent or to make the photosensitive material no longer photosensitive. The optical device may further comprise a plurality of segments each comprising a VHG having the same or different VHG properties (e.g. spacing and/or slant angle).

The spacing and/or slant angle of the VHG may gradually vary across locations on the optical device. For example, the variations are gradual if the spacing and/or slant angle only vary substantially over a distance on the photosensitive material greater than the wavelength of the first beam. The variation in spacing and/or slant angle can be sufficiently gradual to avoid aberrations when the optical device comprising the VHG is used at the predetermined wavelength for which it is designed. As a guide, the variation in the VHG over a distance of the wavelength of the incident beam may be less than 20% of the value of the spacing and/or slant angle. Optionally, the variation in the VHG over a distance of the wavelength of the incident beam may be less than 10% or 5% of the value of the spacing and/or slant angle.

The spacing and/or the slant angle of the volume holographic grating may vary in two dimensions across a plane of the optical device. For example, the slant angle of the VHG may varying in a first direction across locations of the optical device and also vary in a second direction across locations of the optical device such that the first and second directions span the plane of the optical device. Alternatively or additionally, the spacing of the VHG may vary as such. Alternatively, the spacing may vary along the first direction while the slant angle varies along the second direction. In general, the plane is parallel to the surface of a material which comprises the VHG. The plane may be curved, either uniformly or non-uniformly.

The two-dimensional spatially varying VHG may have a plurality of contours (i.e. a closed loop of locations) in the plane of the optical device. The VHG at each point along an individual contour has a constant characteristic and corresponding VHG parameters of slant angle and spacing. Different contours have different value for the characteristic and corresponding VHG parameters. The characteristic may be an angle of incidence of light and wavelength which the optical device blocks and the corresponding VHG parameters for the polar slant angle and spacing to block that wavelength at that incoming angle of incident. The azimuthal angle may vary around each contour between 0 and 360 degrees to block that angle of incidence coming from any direction. The angle of incidence at which each contour blocks may be larger for outer contours further from the central location. Hence there is a region behind the optical device which is shielded from a certain wavelength of light from any direction.

In another aspect of the disclosure an apparatus for making a spatially-varying volume holographic grating in a photosensitive material comprises a support arranged to dispose a photosensitive material. For example, the photosensitive material can be placed on the support to position the photosensitive material. Optionally, the photosensitive material can be releasably attached to the support in order to perform a method as described above.

The apparatus comprises a beam producing system comprising one or more light sources, wherein the beam producing system is arranged to produce a first beam of light and a second beam of light to produce a volume holographic grating in the photosensitive material. The beam producing system may comprise a single light source, which is then either split or reflected to form the first and second beams. For example, the beam producing system may comprise a beam splitter to split a beam produced by a first light source into the first beam and the second beam. As another example, the first beam may be reflected off a reflective component to produce the second beam. Alternatively, the beam producing system may produce the first and second beams independently, e.g. by different light sources. The light sources of the beam producing system may be components which generate light, e.g. a laser, or may be components which direct light generated elsewhere, e.g. the output end of an optical fibre attached at the other end to a laser. The VHG is produced in the photosensitive material by producing an interference pattern between the first and second beams in the photosensitive material, as for the methods described above. The VHG volume holographic grating comprises periodic grating features spaced along a grating direction by a spacing and the grating direction forms a slant angle with respect to a surface of the photosensitive material, wherein the spacing and slant angle are described further above.

The apparatus further comprises a gantry system to scan the first beam and the second beam across locations on the photosensitive material and a controller arranged to control the gantry system to scan the first and second beams across locations on the photosensitive material. The controller may be a component or combination of components which produce one or more control signals which are communicated to other components of the apparatus which require controlling. For example, a control signal may be sent to a motor to position the first and second beams over the support (and photosensitive material if placed thereon). Controlling the gantry system may include, for example, setting a scan path and the speed and direction of the scan at each position along the scan path. The one or more control signals may be sent electronically or wirelessly via a communication system.

The controller is further arranged to control the light source and/or the gantry system to vary one or more parameters of the first beam and the second beam to vary one or both of the spacing and the slant angle of the volume holographic grating across locations on the photosensitive material. The control signals of the controller may therefore determine the wavelength of a tunable wavelength light source. The control signals may further control a motor to change the angle of incidence of either the first beam, second beam, or both. This can be by rotating the angle of the first or second beam or by changing the angle of the support and/or photosensitive material. In apparatus including a reflective component to reflect the first beam to produce the second beam, the controller may produce control signals for a motor to control the positioning and rotation of the reflective component. The controller may produce control signals to control any of the moving parts of the apparatus and/or the variables of the light source. An example of the controller is an electronic circuit in communication with other components of the apparatus to send control signals to the components. As another example, the controller may be a computer or processor which sends control signals to components to instruct the performance of the apparatus.

The gantry system may be a two-dimensional gantry system arranged to scan the first beam and the second beam across locations on the photosensitive material in two dimensions. For example, the positions over which the first and second beams can be scanned is a two-dimensional area. This apparatus can therefore produce a VHG which varies slant angle and/or spacing in two dimensions and can produce more versatile optical devices.

The controller may be arranged to control the beam producing system to vary a wavelength of the first beam or second beam. If the second beam is derived from the first beam, e.g. by reflection or beam-splitting, then controlling the wavelength of the first beam also determines the wavelength of the second beam. If the first and second beams are produced independently, the controller may vary a wavelength of only one of the first and second beams, control both in coordination, or control each beam independently.

The gantry system may comprise a first scanning head arranged to direct the first beam from the beam producing system onto the photosensitive material and the controller may arranged to control the first scanning head to vary an angle of incidence beam onto the photosensitive material of the first beam and/or the second beam. The first scanning head may further comprise a mirror assembly having a first mirror, wherein the first mirror is rotatable to vary the angle of incidence of the first beam onto the photosensitive material. For example, the beam producing system may direct the first beam from the light source onto the first mirror (possibly via intermediary components) which reflects the first beam onto the support or a photosensitive material disposed thereon. The first mirror may rotate in one or more directions, e.g. be a galvanometric mirror. The mirror assembly may further comprise a second mirror, wherein the second mirror is an elliptical mirror having first and second focal points, wherein the first mirror is located coincident with the first focal point and the support is arranged to dispose the photosensitive material to be located coincident with the second focal point. For example, the first light beam is incident on the first mirror, which rotates to control the location of incidence on the second, elliptical, mirror which reflects the first beam towards the support, or onto photosensitive material disposed thereon. The mirror assembly arranged in this way allows the angle of incidence of a beam to be changed without changing the location of incidence. This simplifies the scan path which a first scanning head takes.

The first scanning head may comprise a gimbal for varying the angle of incidence onto the photosensitive material of the first beam or the second beam, wherein the gimbal is coupled to an end of an optical fibre arranged to transmit light from the at least one light source. Alternatively or additionally, the first scanning head may comprise a gimbal for controlling the second beam likewise. This can simplify the gantry system by removing the need for multiple mirrors to direct the beam onto the photosensitive material.

The support may be a reflective component arranged to reflect the first beam to form the second beam, which simplifies the arrangement and is particularly suitable for producing zero slant angle VHGs. Alternatively, the beam producing system may comprise a reflective component arranged to reflect the first beam to form the second beam. In either alternative, the reflective component is one of: a planar mirror; a curved mirror; a planar optical device comprising a volume holographic grating with a non-zero slant angle; or a curved optical device comprising a volume holographic grating with a non-zero slant angle.

The apparatus may further comprise a reflective component gantry arranged to scan the reflective component in coordination with scanning the first beam. The reflective component may be arranged to rotate in coordination with scanning the first beam. For example, the controller may control the reflective component gantry such that the reflective component reflects the first beam along a path such that an interference pattern in the photosensitive material to be disposed on the support. This provides an apparatus for producing a varying slant angle VHG.

The support may be contoured such that when the photosensitive material is on the support, the slope of the photosensitive material varies across locations of the photosensitive material. The slope of the photosensitive material caused by the support may vary in one or two dimensions uniformly or non-uniformly. Alternatively, the surface of the support on which the photosensitive material is arranged is opposite a surface of the support which is reflective and contoured. The angle of slope of the opposite surface under each point of the photosensitive material will, in use, determine the orientation of the interference pattern in the photosensitive material and thereby control the slant angle of the VHG at that point.

The apparatus may further comprise a surface on which the support is arranged to sit, wherein the surface comprises a plurality of air holes arranged to provide a stream of air between the support and the surface to reduce friction between the surface and the support and arranged to provide air suction to hold the support to the surface. The stream of air may be controlled by the controller to facilitate fixing or moving the support, and photosensitive material thereon, with respect to the rest of the apparatus.

The apparatus may further comprise an actuator arranged to move the photosensitive material with respect to the gantry system. The actuator may be controlled by the controller to move the photosensitive material, optionally by controlling the support. The actuator may further be arranged to unroll the photosensitive material from a first spool to a second spool through the first beam and second beam. This provides an automated system for producing large area VHGs and/or a large number of VHGs.

In another aspect of the disclosure a system for producing an optical device comprising a spatially-varying volume holographic grating in a photosensitive material comprises an apparatus as described above and a processing unit for instructing the controller to control the spacing and the slant angle of the volume holographic grating across locations on the photosensitive material. The processing unit may also instruct the control to control any of the other parameters or components of the apparatus as described above.

### BRIEF DESCRIPTION OF THE FIGURES

Specific embodiments are now described by way of example and with reference to the accompanying drawings, in which:

FIGS. 1A and 1B show two optical devices comprising a uniform VHG;

FIGS. 2A and 12B show optical devices having spatially-varying VHGs;

FIG. 3 shows an VHG map with contour lines indicating locations of constant VHG parameters;

FIG. 4 shows an interference pattern caused by an incident beam and its reflection off a mirror;

FIGS. 5A, 5B and 5C show three arrangements for producing a VHG in a material with different slant angles;

FIG. 6 is an overhead view of a gantry scanning system;

FIGS. 7A, 7B, 7C and 7D show four arrangements of a scanning head;

FIG. 8 is a schematic side view of an apparatus for producing a slant VHG;

FIG. 9 is an isometric view of an apparatus for producing a slant VHG;

FIG. 10 is an isometric view of an apparatus for producing a slant VHG;

FIG. 11 is an isometric view of an apparatus for producing a slant VHG;

FIG. 12 is an overhead view of the apparatus shown in FIG. 11;

FIG. 13 is a schematic side view of an apparatus for producing a slant VHG;

FIG. 14 is a schematic side view of an apparatus for producing a slant VHG;

FIGS. 15A and 15B show schematic side views of two arrangements for producing a slant VHG;

FIG. 16 shows a method for making an optical device having a spatially-varying VHG;

FIG. 17 shows a scanning motion of the method of FIG. 16;

FIGS. 18A and 18B show apparatus for producing a VHG in a material;

FIG. 19 is an overhead view of a gantry scanning system tracing a scan path;

FIG. 20 shows a graph of blocking angle as a function of position along a line across a spatially-varying VHG;

FIG. 21 is an overhead view of a gantry scanning system tracing a scan path;

FIG. 22 is a side view of a gantry scanning system tracing a scan path;

FIG. 23 is an overhead view of a gantry scanning system tracing a scan path;

and

FIG. 24 shows a system for producing spatially-varying VHGs.

### DETAILED DESCRIPTION

In overview, methods for producing optical devices having spatially-varying volume holographic gratings (VHGs) are disclosed, as well as apparatus for implementing the methods and optical devices manufactured using these methods/apparatus.

### Introduction to VHGs

To provide context for spatially-varying VHGs, conventional uniform VHGs having uniform properties are discussed below.

For the purpose of this disclosure, uniform VHGs are substantially different from a general hologram, e.g. that of an object, in that the uniform VHGs can be described as a pattern with properties that either are uniform over the full extent of the device. Instead, spatially-varying VHGs may have small variations over a region of the device with dimensions that are large compared to the wavelength of the light targeted by the device's functionality. If variations of a VHG's defining parameters occur on a length scale on the order of the targeted wavelength, aberrations occur that may affect the devices performance. Unless carefully engineered, as for example in the periodic structures of two- or three-dimensional photonic crystals, the performance is typically compromised.

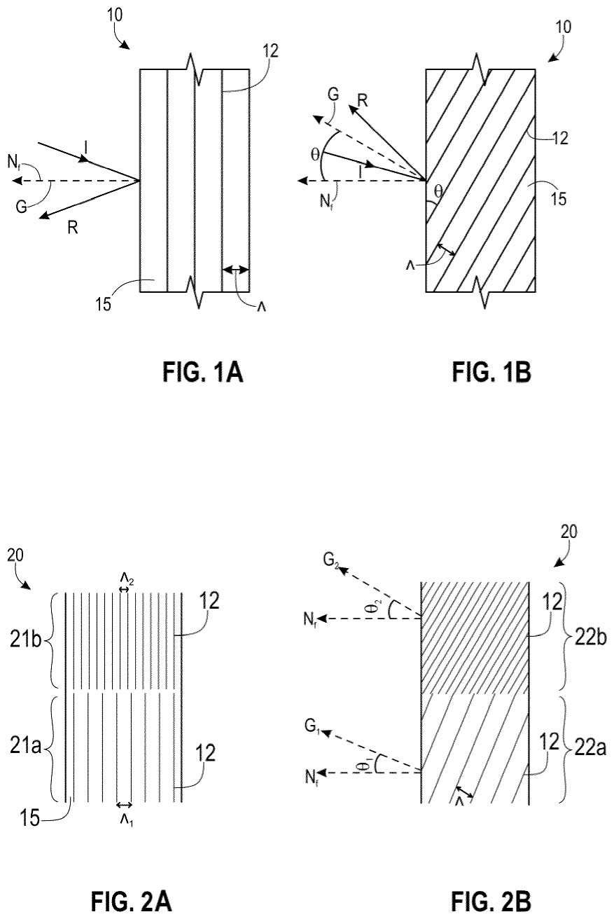

With respect to FIGS. 1A and 1B, an optical device 10 comprises a uniform VHG implemented in a photosensitive material 15. The uniform VHG can be locally described by the grating direction G and spacing Λ of a periodic or near periodic modulation of the refractive index of the photosensitive material. Along the grating direction of the VHG, the refractive index alternates between high and low values, i.e. locally the VHG comprises planes 12 of alternating high and low refractive index that are spaced by Λ. With respect to FIG. 1A, a uniform conformal reflective VHG has these grating planes parallel to the surface of the material, i.e. grating direction G is parallel to surface normal direction Nf. With respect to FIG. 1B, a uniform slanted VHG has the grating planes slanted by a polar slant angle θ with respect to the surface material, and the grating direction G and the surface normal Nf enclose the same angle θ. Additionally, the projection of the grating direction G of a slanted VHG onto the surface of the medium provides the azimuthal direction of the slanted VHG, measured by the azimuthal slant angle that is enclosed by the azimuthal direction and a fundamental direction parallel to the surface of the medium. For a conformal VHG with a slant angle of θ=0, the azimuthal slant angle is undefined. Throughout the description, the slant angle should be understood to comprise both the polar slant angle θ and, when the polar slant angle is non-zero, also the azimuthal slant angle ϕ.

When a beam of light l of a specific wavelength λ₀ is incident with an angle S relative to the VHG grating direction G, it will be reflected off the VHG if the Bragg condition

λ₀=2λn cos(δ) (1)

for maximal diffraction due to constructive interference is matched, where n is the average refractive index of the medium that contains the VHG. Here, the wavelength λₒ is defined in vacuum and relates to the wavelength in the medium through the relation λ=λ₀/n. The angle δ is understood as its value inside the medium containing the VHG and its relation to the incidence angle of the light onto the optical device is discussed through Snell's law below. The Bragg condition implies that the wavelength reflected by a device comprising a VHG can be engineered by changing both or either of the spacing Λ and the relative angle δ, where the latter contains the incidence angle of the light on the device and the polar slant angle of the VHG.

For small deviations from the Bragg condition, the reflectivity of the VHG decreases only slightly, giving rise to a finite range of relative angles of incidence δ and wavelengths λ for which the VHG is effective. For larger deviations, the reflectivity is substantially decreased and vanishes. The range of angles of incidence or wavelengths for which the VHG reflects a fraction that is greater than a threshold value is referred to as, respectively, the angular or spectral bandwidth. For a given spectral bandwidth, the angular bandwidth is largest for small relative angles δ, since the cosine in the Bragg condition changes nearly quadratically around δ=0. For larger relative angles, the cosine in the Bragg condition changes nearly linear and the angular bandwidth for a given spectral bandwidth becomes smaller.

In an application, where light is incident on the surface of the medium that contains the VHG from the surrounding environment with refractive index nₑₙᵥ (typically air with nₑₙᵥ≈1.0), the light will be refracted at that surface and the angle of incidence changes from α in the surrounding environment to β in the medium containing the VHG, obeying Snell's law:

nₑₙᵥ sin α=n sin β (2)

The azimuthal angle of the light with respect to a fundamental direction parallel to the surface of the medium does not change when the light passes through the surface. If that azimuthal angle matches the azimuthal slant angle of the VHG, the relative angle between the incident beam in the medium and the VHG grating direction G is

δ=β−θ, (3)

and therefore β directly enters the Bragg condition. For a conformal VHG (θ=0), δ=β, and the angular bandwidth of the VHG is largest around β=0, and correspondingly around α=0. For larger incidence angles in the surrounding environment, α, the angular bandwidth of the VHG becomes smaller, since Snell's law provides a nearly linear relation between α and β, as long as neither is too large. When n>nₑₙᵥ, the largest angle of incidence in the medium that contains the VHG, β=βₘₐₓ, is reached for grazing incidence, i.e. ƒₒᵣ amax=90°, where

$${β}_{max} = {sin}^{- 1} ( \frac{{n}_{e n v}}{n sin ( {α}_{max} )} ) = {sin}^{- 1} ( \frac{{n}_{e n v}}{n} ) \qquad ( 4 )$$

Around grazing incidence, Snell's law provides a nearly quadratic relation between α and β. As a consequence, the angular bandwidth of the device comprising the VHG that is effective in the surrounding environment becomes large again.

### Spatially-Varying VHG—Structure

The inventors have a developed methods and apparatus for making optical devices having VHGs with a spatial variation of the spacing and/or slant angle across locations of the device. The structure and performance of these spatially-varying VHGs is described as follows.

With reference to FIG. 2A and FIG. 2B, optical devices 20 having a VHGs formed in a photosensitive film 15 can have spatially-varying slant angle/spacing. The principles of grating features 12 and the parameters of spacing Λ and slant angle, comprising the polar slant angle θ and azimuthal slant angle ϕ, are the same as described above.

With reference to FIG. 2A an exemplary optical device 20 comprises a VHG having different spacing values across the film. Specifically, the VHG has a first spacing Δ1 in a first region 21a and a second spacing Δ2 in a second region 21b. With reference to FIG. 2B, another exemplary optical device 20 comprises a VHG having different slant angles across the film, specifically a first slant angle θ1 in a first region 22a and a second slant angle θ2 in a second region 22b, and corresponding grating directions G1 and G2. It will be appreciated that while spacing and slant angle have been described as separately varying, a VHG in an optical device 20 may have variations in both slant angle and spacing across locations of the film. The VHG may include any combination of regions having the same slant angle and different spacings, regions having the same spacing and different slant angle and regions varying in both slant angle and spacing. Equally, it will be apparent that the disclosure is not limited to variations between two regions but encompasses any number of regions. Additionally, at the transition between regions and/or locations of different slant angle and/or spacing, there may be a continuous transition. That is, there is a gradual variation in slant angle and/or wavelength between the first region and the second region, or additional regions. The transition of slant angle and spacing is sufficiently gradual to avoid aberrations when the optical device is used. While FIG. 2B only illustrates a variation in polar slant angle, the azimuthal slant angle can be varied in addition to, or instead of, the polar slant angle.

While only a few grating feature repeat patterns are shown in FIGS. 1A, 1B, 2A and 2B for simplicity of illustration, it will be appreciated that in practice there will be dozens, hundreds, or more repeat patterns of grating features 12 across the film 15 in the grating direction G. Likewise, the spacing in the figures is schematic, in optical devices the spacing will generally be on a subwavelength scale such that the Bragg condition can be satisfied. The schematic drawings of FIGS. 1A, 1B, 2A and 2B show sample sections of the optical devices for illustrative purposes and the optical devices can extend further beyond the sections shown.

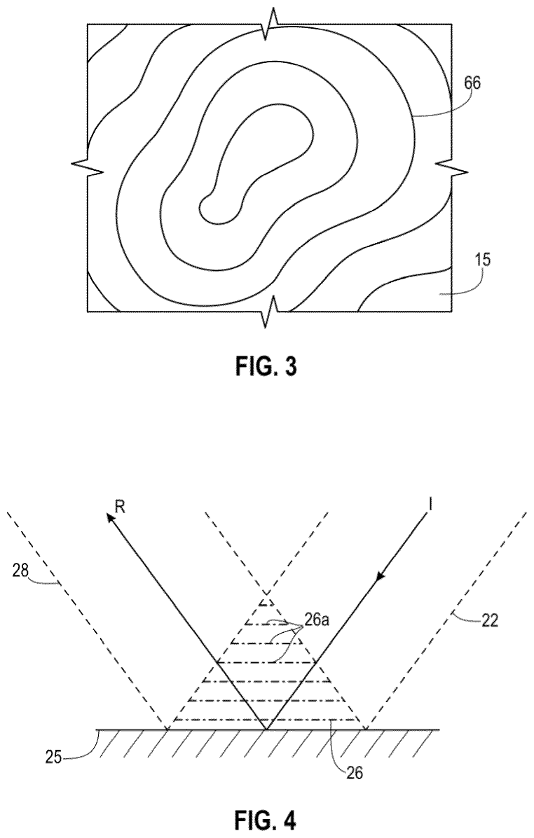

With reference to FIG. 3, the spatially-varying parameters of a VHG can be represented by a VHG map. The VHG map is a visual description of how the features of a VHG vary across a photosensitive film 15. Contour lines 66 connect all locations having the same value of a certain parameter. For example, each contour line may indicate the locations on a photosensitive film 15 which have the same specific angle of incidence which is blocked (e.g. reflected). This in turn relates to values of the spacing of the VHG and/or slant angle of the VHG. Different contour lines indicate different specific values for the indicated parameter. There is no specific requirement of the number of contours represented, having more contours will simply result in a more precise description of how the parameters of the VHG vary across the surface of the photosensitive film 15.

The contours of a VHG map, e.g. as illustrated in FIG. 3, may indicate any particular parameter of the VHG. For example, the VHG map may indicate parameters describing the effect of the VHG, such as angle of light blocked at each location or wavelength blocked at normal incidence. In other examples, the VHG map may indicate parameters describing the structure of the VHG including slant angle and spacing. Having one or more VHG maps, e.g. one for spacing and one for slant angle, provides a comprehensive description of the VHG.

While each contour indicates a single value of a particular parameter, other parameters of the VHG can vary along the contour. For example, the contours which form a complete loop may indicate a constant polar slant angle but have an azimuthal slant angle which varies from ϕ=0 to ϕ=360 degrees around the loop.

VHG maps can be useful for quantifying and recording a specific VHG and how these vary across the surface of the photosensitive film 15. For example, the desired VHG map for a particular application can be stored in a computer memory and then used by apparatus as part of a method for producing the VHG. It can be determined from the VHG map what is the necessary wavelength, angle of incidence, or indeed any other parameter, required at each location to create the desired VHG. The VHG maps of specific advantageous or commonly produced VHGs can be stored in the computer memory and recalled each time that particular VHG is to be produced.

### Spatially-Varying VHG—Performance

As a result of the variations between regions at different locations of a VHG, as described above, the values of wavelength and angle of incidence for which the Bragg condition is met in each region will be different from each other. This means that different angles and/or wavelengths will be reflected at each of the regions 21a, 21b, 22a, 22b. In some embodiments, a particular combination of spacing and slant angle is controlled at each location to achieve the desired effect on incident light based on the Bragg condition. For example, the resulting optical device may function as a filter and have a particular wavelength and angle of incidence of light which is blocked (i.e. reflected) at each location on the optical device.

For optical devices with VHGs having gradually varying spacing and/or slant angle, each local region (e.g. on a sub-wavelength scale) of the VHG has substantially constant values will perform similar to a uniform VHG. Hence the change in spacing and/or slant angle does not cause aberrations which would be detrimental to the performance of the VHG. However, over larger regions, the variation in VHG parameters produce different effects on incident light. Hence the optical device can have advantageously controlled functionality across locations of the device.

### Apparatus for Producing Spatially-Varying VHGs

The principle components of exemplary apparatus for producing spatially-varying VHGs are described below with reference FIG. 4-8.

In order to produce a VHG in a photosensitive material, apparatus is provided to produce an interference pattern between two beams of light. With reference to FIG. 4, an interference pattern 26 results from interference between the incident beam 22 and the reflected beam 28, reflected off a reflective component 25, such as plane mirror or a VHG. The incident beam 22 can be represented by the incident ray I and the reflected beam 28 can be represented by the reflected ray R, although in practice each beam has a non-zero beam width. In the region where the incident beam 22 and reflected beam 28 overlap, the interference pattern 26 is produced. The interference pattern has intensity maxima 26a where constructive interference occurs and intensity minima between the maxima 26a where destructive interference occurs. The planes of maxima 26a are parallel to the plane of reflection, which in the case of FIG. 4 is the plane of the plane mirror. The interference pattern can be produced if the beams have sufficiently long coherent length, for example from a monochromatic laser. The spacing of maxima 26a depends on the wavelength of the incidence light l and the angle of incidence onto the mirror plane according to:

$${d}_{f} = \frac{λ}{2 n {cos θ}_{i}} \qquad ( 5 )$$

Wherein df is the distance between maxima (also known as fringes), λ is the wavelength of light, and θi is the angle of incidence with respect to the mirror plane (and hence 2θi is the angle between the incident and reflected beams). Changing the wavelength and/or the angle of incidence of the incident beam will change the spacing between maxima, and therefore the spacing Λ of a VHG made using this interference pattern.

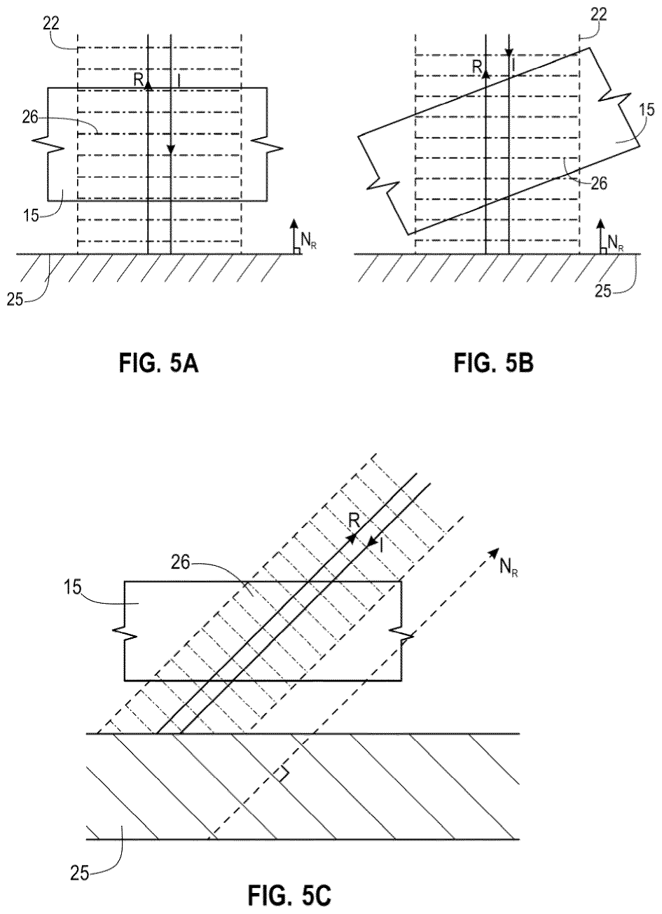

In addition to apparatus which can produce an interference pattern, the apparatus for producing a VHG further comprises a photosensitive material located at least partially in the interference pattern. With reference to FIG. 5A-C, three arrangements are described for producing a VHG in a material such as a photosensitive film 15. A film 15 is referenced for ease of description but it will be appreciated that a plate or other form of material may be used in place of the film 15. With reference to FIG. 5A, an arrangement similar to FIG. 4 comprises the incident beam 22 reflected off a plane mirror. In FIG. 5A however the incident beam 22, represented by incident ray I, is incident along the normal N_{R} of a plane mirror (i.e. angle of incidence is zero). Hence the incident beam 22 is retro-reflected by the plane mirror, i.e. reflected back along the same angle of incidence. The reflection of incident beam 22 is represented by reflected ray R. The incident and reflected beams therefore overlap over substantially the whole beam path. A film 15 positioned in the beam path will therefore be exposed an intensity profile corresponding to the interference pattern. A VHG will then be formed in the photosensitive film 15 with grating features corresponding the interference maxima, as described above. With reference to FIG. 5B, it will be appreciated that if the film 15 is disposed an angle to the plane mirror, then the interference pattern will be angled relative to the film 15, resulting in a slanted VHG.

With reference to FIG. 5C, in some embodiments the reflective component 25 is itself a device comprising a VHG. When the incident beam reflects off the reflective component, the resulting interference pattern 26 will produce a VHG in the film 15 having the same slant angle as the reflective component 25 VHG. However, the spacing of the VHG produced will depend on the angle of incidence of the incident beam onto the reflective component. When the incident beam 22 is normal to the plane of reflection of the reflective component, i.e. parallel to the grating direction (N_{R}) of the reflective component 25 VHG, then the VHG produced in the film 15 VHG will have the same spacing as the reflective component 25 VHG. Accordingly, a VHG is ‘copied’ from the reflective component 25 VHG into the film 15. If instead the angle of incidence is not parallel to the grating direction (N_{R}), the spacing will be different; in this case only the slant angle is copied. Using a device comprising a VHG as the reflective component as described above is applicable to any of the embodiments described herein.

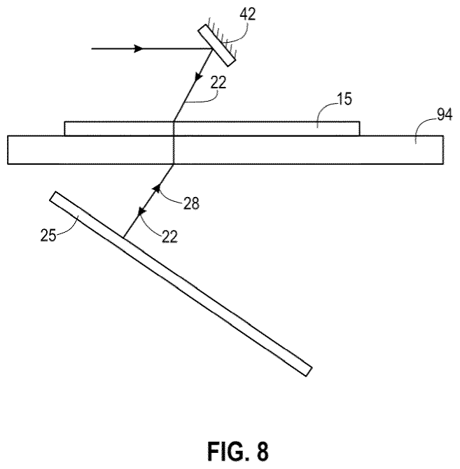

It will be appreciated that the photosensitive film 15 is in practice held by holding means not illustrated in FIG. 5A-C. However, the holding means may be the plane mirror/reflective component itself, e.g. as shown in FIGS. 18A and 18B, which is a support for the photosensitive material. Alternatively, the holding means may be a separate component, such a support as described in more detail below with reference to FIG. 8-15.

Producing a VHG with a non-zero slant angle has the advantage of improved angular bandwidth when producing filters designed for large angles of incidence. As has been described above, Bragg's law is quadratic for small incident angles and becomes linear for larger angles. The latter is a cause behind small angular bandwidth of shifted conformal filters designed to block a specific wavelength under a significant blocking angle. However, slanted gratings with a slant angle that matches the designed in-medium blocking angle offer much improved angular bandwidth, as they again exploit the quadratic regime of Bragg's law (i.e. near normal incidence to the plane of reflection).

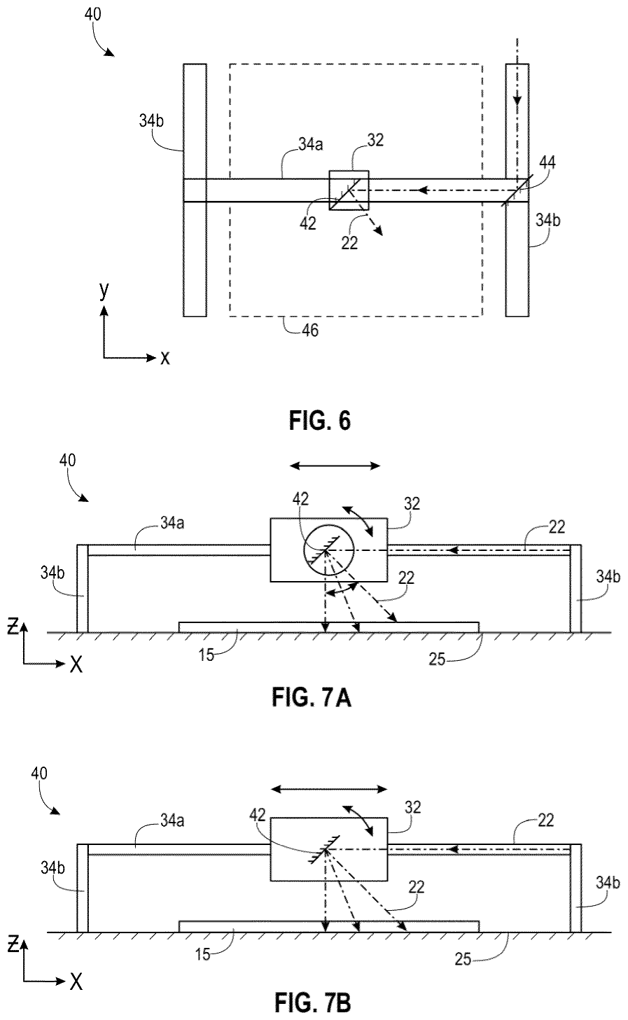

The apparatus for producing a spatially-varying VHG further comprises means for moving the incident beam with respect to the photosensitive material. With reference to FIG. 6, the means for moving the incident beam is a scanning gantry system 40. The scanning gantry system 40 comprises a scanning head 32 which is arranged to scan an incident beam across a recording area 46 where a photosensitive film (not shown) is placed in order to record a VHG in the photosensitive film. The gantry system 40 comprises a first rail 34a moveably secured to a set of second rails 34b disposed on either side of the recoding area 46. The second rails 34b suspend the first rail 34a above the recording area. The scanning head 32 is moveably secured to the first rail 34a above the recording area 46. The scanning head 32 location in the x-direction is determined by the scanning head position on the first rail 34a. The scanning head 32 location in the y-direction is determined by the first rail 34a position on the second rails 34b. The recording area 46 defines the entire region in the x-y plane which can be reached by the scanning head 32 when positioned by the rails 34. In other embodiments, the height of the scanning head 32 over the recording area 46, e.g. the position in the z-direction, can also be controlled. The scanning head 32 may be controlled using a motor (not shown), for example located in the scanning head 32, for precise control of the position and speed of scanning, e.g. a servomotor. Alternatively, the scanning head 32 may be scanned using wires attached on opposite sides of the scanning head or any other suitable actuating means. The scanning head actuating means is controlled by a control unit (not shown) which instructs the actuating means to move the scanning head to a desired position or along a desired scan path. The control unit can receive the desired position or desired scan path from a user input, from computer-readable memory, or as an output of an operation of a processor.

A reflective component may be placed under the recording area 46 so that, when an incident beam 22 passes through the photosensitive film, the incident beam is reflected to interfere with the incident beam 22. The gantry system 40 comprises a mirror assembly 42, 44 which directs the incident beam 22 from a source (not shown) onto the recording area 46. A first mirror 42 of the mirror assembly controls the angle at which the incident beam 22 is directed onto the recording area 46 and is arranged to receive light from the source via the second mirror 44.

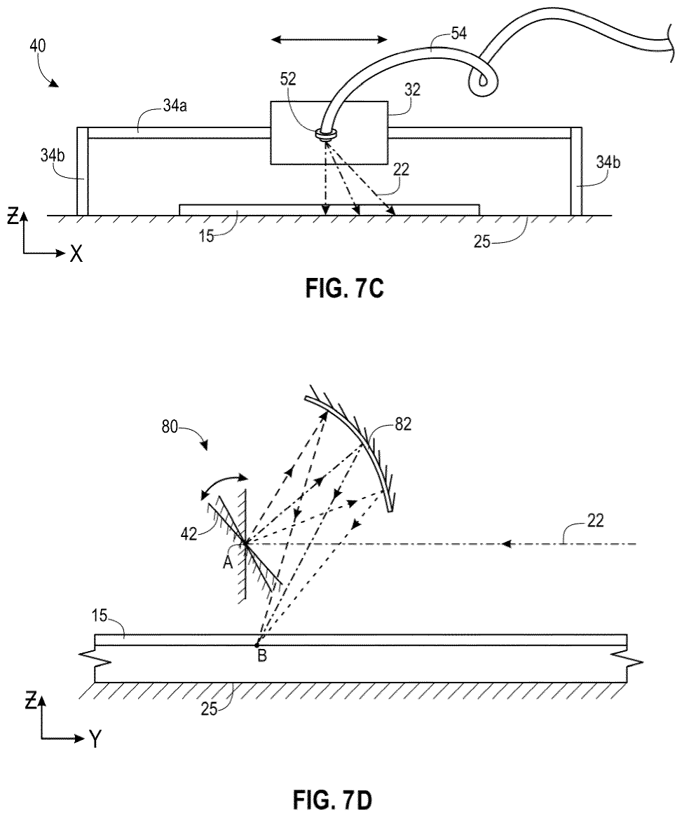

With reference to FIG. 7A-D, four exemplary arrangements of a scanning head 32 are described for controlling the angle of the incident beam 22 onto a photosensitive film 15 in the recording area 46. Hence the scanned head 32 also can control the angle of incidence of the incident beam. It will be appreciated that although these arrangements are illustrated in the context of a film 15 in contact with a reflective component 25, the arrangement of the scanning head 32 is independent of the arrangement of the film relative to the reflective component 25 and is thus applicable to all described embodiments.

With reference to FIG. 7A, the scanning head 32 is arranged with the first mirror 42 secured to a rotating stage. As the scanning head is scanned, the rotating stage can rotate the angle of the first mirror 42 and thereby change the angle at which the incident beam 22 is incidence onto the photosensitive film 15. With reference to FIG. 7B, the scanning head 32 is arranged with the first mirror 42 being a galvanometer mirror which can rotate in two-dimensions to control the direction of the incident beam 22 along a particular polar angle and/or azimuthal angle. With reference to FIG. 7C, the scanning head 32 receives the incident beam 22 through an optical fibre 54. An end of the optical fibre is mounted 54 on a gimbal 52 such that the gimbal 52 can control the angle of the end of the optical fibre and thereby control the angle of incidence in the recording area 46 of the incident beam 22. The gimbal 52 may be arranged with one or two rotational degrees of freedom, as required.

In other embodiments, an elliptic mirror is used in the mirror assembly. With reference to FIG. 7D, the scanning head includes a mirror assembly 80 which receives the incident beam 22, reflects the incident beam off a first mirror 42 onto a second, elliptical, mirror 82. The elliptical mirror 82 reflects the incident beam 22 onto the photosensitive film 15. The mirror assembly 80 is arranged such that a first focal point A of the elliptical mirror is located at (i.e. coincident with) the location at which the incident beam hits the first mirror 42 and such that a second focal point B is located on (or in) the photosensitive film 15. When the first mirror 42 of the mirror assembly is rotated, the angle of incidence of the incident beam 22 is varied, as described above with reference to FIGS. 7A and 7B. However, because of the bi-focal property of elliptical mirrors, the location of incidence at the second focal point B does not vary when the angle of the first mirror 42 is changed. Hence the incident beam can be scanned across the photosensitive film 15 by scanning the mirror assembly 80 across the photosensitive film 15. This causes the second focal point B and therefore the location of incidence of the photosensitive film 15 to be scanned. The mirror assembly may also comprise a further mirror 84 which scans along the first rail 34a along with scanning head 32. Hence the incident beam 22 can reach the scanning head 32 along the first rail 34a and be reflected onto the first mirror 42 by the further mirror 84.

In each of the examples described above with reference to FIG. 7A-D, the scanning head is arranged to control the angle of incidence of the incident beam 22 onto the photosensitive film. The scanning head is controlled by a control unit (not shown). This may be the same control unit described above for the scanning head actuating means, or a separate control unit which performs equivalent functions. The control unit controls a motor or other actuator (not shown) to move the first mirror 42 or gimbal 52, as the case may be, to determine the angle of the first mirror 42 or gimbal 52, the speed of rotation, and/or other parameters. Accordingly, the control unit is arranged to control the angle of incidence at each location of the beam in the recording area 46 in accordance with appropriate control parameters or control functions, to achieve desired outcomes as described below in the methods for producing spatially-varying VHGs.

In some embodiments, the scanning head 32 includes a diverging component (not shown) to increase the divergence of the incident beam 22 before it reaches the photosensitive film 15. In some examples, the diverging component is a lens placed between the first mirror 42 or gimbal 52 such that there is a small spread of angles of incidence when the incident beam 22 reaches the film 15. The divergent component can facilitate a smoother transition between regions having different slant angle and/or spacing.

In some examples of apparatus for use in preparing slanted VHGs, the apparatus comprises components which enable the plane of reflection of the reflective component 25 to vary. As described in the further detail below, this can be done by physically rotating the reflective component 25. Alternatively, a reflective component 25 may have different planes of reflection across its surface, or the film 15 can be contoured so that different locations of the film are at different angles with respect to the plane of reflection. Apparatus comprising these features can produce a VHG with a slant angle which varies across locations of the photosensitive film.

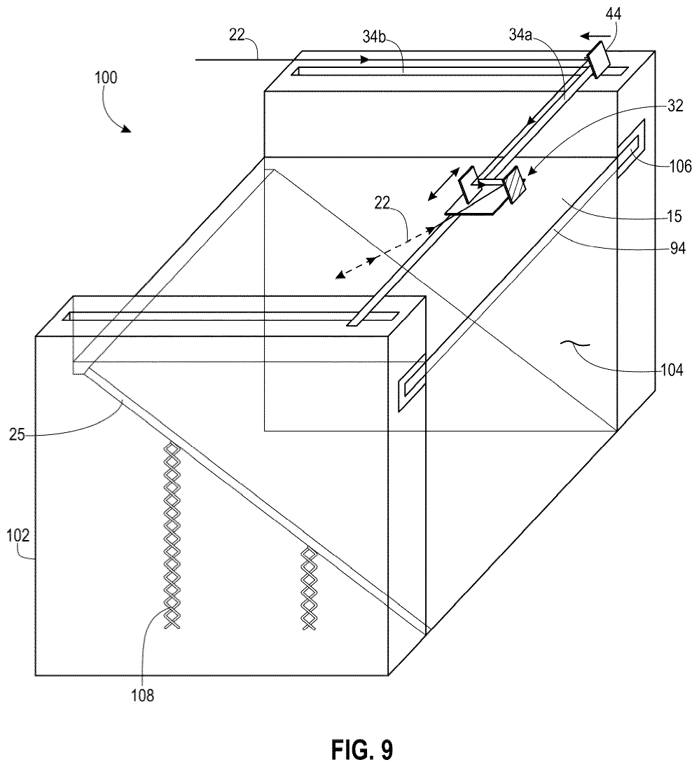

With reference to FIG. 8, an embodiment of an apparatus for producing a slant VHG comprises a first mirror 42 and a reflective component 25 disposed either side of a photosensitive film. The photosensitive film 15 is supported by a film support 94, for example a glass substrate. The film support 94 transmits the incident beam 22 to the reflective component and the reflected beam is transmitted back through the film support to the photosensitive film 15. The film support 94 and photosensitive film 15 are held in place by holding means (not shown) and the first mirror 42 is positioned using a gantry system as described with respect to FIG. 6. The first mirror 42 can be replaced with any form of scanning head as described with respect to FIG. 7A-D. Reflective component 25 is actuated by actuating means (not shown) to control the plane of the reflection of the reflective component and/or to move the reflective component, as described in more detail with respect to FIG. 9-11. For example, the actuation means may include a gantry apparatus for moving the reflective component underneath the photosensitive film and/or a rotating stage for controlling the angle of the reflective component 25. The control of the first mirror 42 and the reflective component 25 is done by a control unit (not shown) and motors (not shown) such as servomotors to produce high control and synchronisation.

The above apparatus, described with reference to FIG. 8, utilises a collimated incident beam 22 for optimal overlap between the incident beam 22 and reflected beam 28, and it is sensitive to their relative transverse alignment (determined by the plane of reflection of the reflective component). Thus, the recording of high quality VHGs in this arrangement relies on the stability of the optical path length between the reflective component 25 and the film support 94 at any position. The optical path length depends on the physical distance between the film support 94 and the reflective component 25, as well as the integral of refractive index along the beam path between film support 94 and reflective component 25. As a result, the reflective component's flatness and mechanical stability have a higher effect on quality of resulting VHGs than for apparatus to produce conformal recordings.

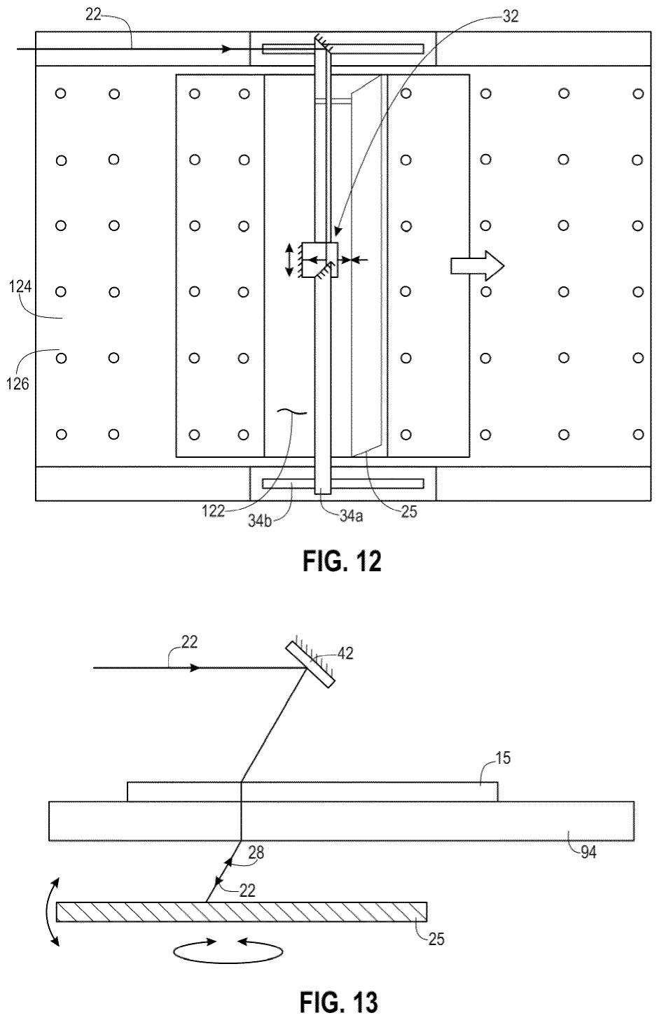

In some embodiments, to achieve high mechanical stability in the recording, the film support 94 comprises a thick glass sheet to minimize the vibration of the glass as well as having a rigid frame for holding the glass substrate. One example is a sliding mechanism with a mechanical or vacuum holder that keep the glass fixed, as described in further detail below with reference to FIGS. 11 and 12.

Exemplary arrangements of apparatus for producing spatially-varying VHGs, and exemplary variations, are described below with reference FIG. 9-15.

A specific implementation of the apparatus described above with reference to FIG. 8, is described as follows with reference to FIG. 9. An apparatus 100 for producing an optical device having a spatially-varying VHG comprises a frame 102 supporting scanning means in the form of rails 34a and 34b for scanning a scanning head 32 across locations of a photosensitive film 15. The scanning means is, for example, the scanning gantry system 40 as described with reference to FIG. 6. The frame holds the film support 94 in place by support slots 106 in the frame. The frame 102 holds the film support 94 between the scanning head 32 and reflective component 25. The photosensitive film 15 is supported by a film support 94. The frame 102 and film support 94 form an enclosed chamber 104, which comprises the reflective component 25. The enclosed chamber 104 improves the stability of the reflective component and photosensitive film by limiting air currents and/or vibrations. This reduces errors caused by air currents, which causes either small erratic changes to the reflective component angle or to the refractive index of the air between the reflective component and photosensitive film which affect the optical path length. The reflective component is actuated by a jack 108. The jack 108 raises or lowers one side of the reflective component in order to control the angle of the reflective component, pivoting about the opposite side of the reflective component. Alternatively, the jack may raise or lower either side of the reflective component independently to control both the angle and height of the reflective component. Any actuation means for positioning the reflective component with respect to the photosensitive film 15 is suitable.

The scanning head 32 may be any of the scanning head types described in reference to FIG. 7A-D, or other scanning heads. The scanning head is arranged to scan the incident beam 22 of light across locations on the photosensitive film 15, irradiating the photosensitive film with the incident beam 22. A mirror 44 is mounted on the first rail 34a to reflect the incoming incident beam 22 from the source to the scanning head regardless of the positioning of the scanning head.

The apparatus 100 can be used to receive the incident beam 22 from a source, such as a laser, and direct the incident beam 22 onto the photosensitive film via a first mirror 42 of the scanning head 32. The scanning head 32 controls the angle of incidence of the incident beam onto the photosensitive film 15. Optionally, the incident beam 22 is directed to the scanning head by a second mirror 44. Although a gantry system having rails 34a, 34b is shown in FIG. 9, any scanning means described herein can be used in conjunction with the apparatus 100.

The apparatus 100 can be used for a method to produce VHGs in a photosensitive film 15, including spatially-varying VHGs. As the scanning head 32 scans the incident beam 22 across locations on the photosensitive film 15, the jack 108 actuates the reflective component so that the plane of reflection of the reflective component 25 (i.e. the plane of the mirror) is varied with respect to the photosensitive film 15. This varies the orientation of the interference pattern between the incident beam 22 and reflected beam 28 in the photosensitive film and accordingly controls the slant angle of the VHG in the photosensitive film 15. Instead of a jack 108, other precise rotating means are suitable for adjusting the angle of the mirror.

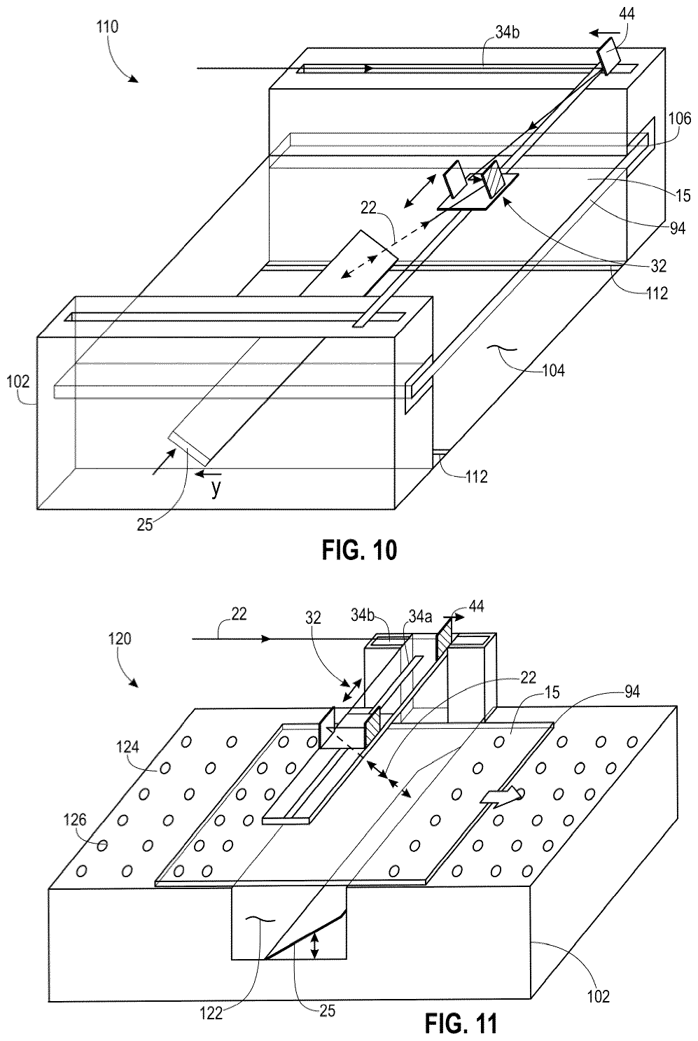

With reference to FIG. 10, in some embodiments, instead of a reflective component 25 having a similar size to the photosensitive film, as shown in FIG. 9, a smaller reflective component 25 is used. This arrangement can be combined with any of the arrangements for the reflective component, e.g. a plane mirror, conformal or slanted VHG and so forth. In particular, the reflective component 25 has a reduced dimension in the direction in which it is scanned. The reflective component 25 is scanned and rotated by a reflective component gantry 112. The reflective component gantry 112 can have the same form as the scanning gantry system 40 described above, with reference to FIG. 6, for scanning the scanning head. For example, the scanning gantry may comprise two or more rails with mounts which can slide along the rails. The reflective component is rotatably coupled to each mount, so that it can scan back and forth below the photosensitive film 15 and also rotate in order to control the slant angle in a resulting VHG in the photosensitive film. Compared to embodiments with larger reflective components which rotate and do not scan, the frame 102 can have a lower height since the reflective component 25 can be rotated around 180 degrees even if the enclosed chamber 104 has a smaller size.

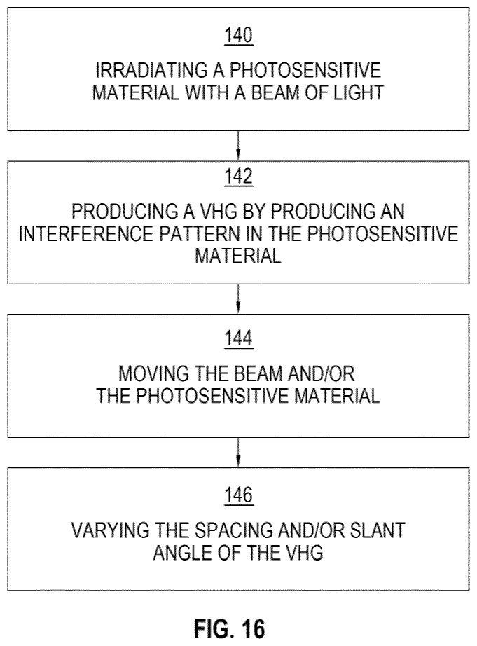

In the process of producing a slant VHG in the photosensitive film 15 with apparatus having a smaller reflective component 25 as described above, the reflective component 25 is scanned and rotated so that the incident beam 22 is retro-reflected from the reflective component 25 to form the reflected beam 28 which interferes with the incident beam 22 in the photosensitive film 15. The other details of this process for producing a slant VHG are described below with reference to FIG. 16.

Having a smaller reflective component, such as shown in FIG. 10, is especially effective for increasing the mechanical stability of the scanning apparatus due to lower weight and facilitated mounting. With improved mechanical stability comes improved reliability of the process producing VHGs in photosensitive films 15 having a large scale (i.e. large length and width).

One issue with creating spatially-varying VHGs with a moving reflective component 25 is that the reflective component 25 should be stationary during the scanning of the incident beam 22. This is because continuous movement in the reflective component 25 along a direction that is not parallel to the plane of reflection will result in a continuous shift in the position of the maxima in the intensity pattern. This causes a smearing of the grating features because the parts of the photosensitive film 15 which are exposed to a maximum intensity changes over time. The result is that the index modulation that constitutes the VHG is washed out or, at best, less pronounced. To avoid this, the photosensitive film is exposed to the interference pattern in one section of the film and then the reflective component 25 can move to a new position in the y-direction and/or rotational position to expose a different section. To achieve precise alignment, the reflective component gantry 112 and the scanning head gantry system 40 should be controlled to move the reflective component 25 and scanning head 32 in synchronization.

An issue with recording a VHG in the photosensitive film 15 in finite patches rather than continuously is that there may be a visible line between the two recorded regions, since there could be an offset between the grating in each region. This would not affect the optical performance of the VHG with respect to the Bragg condition (equation 1) but may be visible to a user. In general, this is less of an issue for reflective components having a larger width, since a larger area can be scanned without needing to move the reflective component. Nevertheless, there are some further ways, outlined below, to reduce the border effects between patterned regions of a photosensitive film.

One possible arrangement to reduce border effects is to merge the two regions having different VHG parameters by fading the sharp borders. This can be achieved by fading out the VHG features close to the borders by dimming the laser power and over-writing the same border region on the photosensitive film after reflective component has been moved to the new position.

In another arrangement to reduce border effects, a feed forward system can be integrated to the scanning apparatus. In this arrangement, an interferometric system is added to the reflective component 25, which precisely measures the distance between the film support and the reflective component 25. The measurement can be either via reflection off the glass substrate or via reflection off an already recorded part of the VHG. When the reflective component moves in the y-direction, an algorithm can calculate the phase-shift offset between the previous and new positions. This corresponds to a shift in locations of maxima of the interference pattern between incident and reflected beams. The apparatus then adjusts the optical pathlength between the reflective component and the photosensitive film, e.g. by using a piezoelectric component. This is done to precisely adjust the position of the interference pattern in the photosensitive film to have a continuous and smooth transition of the resulting VHG between the two regions.

Alternatively, the wavelength of the recoding beam may be adjusted by an amount small enough to avoid a perceivable disruption of the interference pattern throughout the thickness of the photosensitive film. Since the distance between the film and the reflective component mirror can be very large compared to the thickness of the film, such a small change is suitable to adjust the position of the interference pattern inside the film. This second approach can be achieved using either or any combination of tunable laser, an acousto-optical device and an electro-optical device.

With reference to FIGS. 11 and 12, in some embodiments an apparatus for producing an optical device having a VHG includes a table 124 to support the film support 94. The table 124 can be any surface on which the film support 94 and photosensitive film 15 sits and braces them against bending or vibrations, in general a rigid flat surface. The table 124 and the film support 94 enclose a trench 122 underneath the scanning area where the reflective component 25 is mounted. The trench width is smaller than the width of the film support 94 and hence the film support 94 is supported by the table 124 on either side of the trench 122. This reduces the area of the film support unsupported over the reflective component, i.e. in the recording region under the scanning head. Accordingly, the film support 94 in scanning region has greater mechanical stability and will be less prone to vibrations and/or bending. This arrangement can be combined with any of the arrangements for the apparatus described above, such as described with reference to FIGS. 9 and 10. Specifically, the reflective component may be configured as described above with reference to FIGS. 9 and 10, or as described below with reference to FIG. 13 and may be configured as plane mirror, conformal or slanted VHG and in any of these cases can be mounted stationary, on a gantry or able to move with additional, e.g. rotational, degrees of freedom.

The reflective component 25 is moved by actuating means (not shown), attached on a rotation stage and/or a gantry 112 as described with reference to FIG. 10, so that it can be synchronized with the scanning head 32 on the gantry system 40 to adjust the slant angle of VHG to be produced. The reflective component 25 and actuating means can be the same as described with reference to FIG. 9 or 10. In some embodiments, the table comprises air holes 126 to provide a stream of air (or air cushion) to float the film support 94 above the table 124 so that the film support can move freely across the table without substantial friction or scratching the surface. The flow of air can be reversed so that the film support becomes fixed on the table due to suction. The positive or negative pressure required to achieve the desired outcome is provided by one or more pump (not shown), preferably computer-controlled, coupled to the air holes by respective manifolds and conduits (not shown).

The film support and photosensitive film can be controlled for precise alignment between the scanning head 32 and reflective component. This can be achieved by actuating means attached to either side of the film support, such as a gantry system, or actuators such as rods or wires to push and/or pull the film support 94 across the area between the scanning head 32 and reflective component.

Using the apparatus described with reference to FIGS. 11 and 12 and including a table 124 with air holes 126, the apparatus 120 can scan the photosensitive film 15 and record a VHG in finite regions. Once the scanning head 32 has scanned a first region to produce a VHG in the photosensitive film 15, the air holes 126 provide a stream of air under the film support 94 and photosensitive film 15 while the actuating means move the film support 94 and photosensitive film 15 to a new position for another region to be scanned. Once the film support and photosensitive film 15 have moved to the new position, the air holes 126 can reverse the air streams to suck the film support onto the table keep it rigid and mechanically stable during the recording process.

Using an apparatus as described above with reference to FIGS. 11 and 12, the process for producing a spatially-varying VHG may be implemented with improved mechanical stability and improved reliability. In processes for producing VHGs in a large size of film, at a certain size, e.g. at the scale of a metre or more, the reliability of the process will be limited by the stability of the film support 94. At large photosensitive film sizes, it is increasingly hard to keep the film support (and photosensitive film upon it) vibration free and keep it from bending, both of which could decrease the quality of the resulting VHG. For the cases where a very large film is required, the film support can be mechanically supported using the apparatus described above including the table 124 for supporting the film support 94.

All the previously mentioned techniques can be integrated in this arrangement as well, e.g. to avoid or reduce the border effects between the recorded regions.

Some exemplary variations of the above apparatus, having different types of reflective component 25, are described below.

With reference to FIG. 13, in some embodiments, a reflective component 25 having a plane of reflection not normal to its surface can be used, such as an optical device comprising a VHG with a non-zero slant angle (also referred to as a “slant mirror”). These can be used instead of the reflective component in the apparatus described above. In embodiments with this type of reflective component, the angle at which the incident beam 22 is retro-reflected is not normal to the surface of the reflective component. Consequently, the angle of the reflective component 25 with respect to the photosensitive film is not required to be as large compared to if a plane mirror is used. Therefore, the reflective component 25 can be located closer to the photosensitive film. This creates a more compact arrangement and reduces undesirable effects caused by the gap between photosensitive film and reflective component, such as changing optical path length. The reflective component in these embodiments is either fixed or moveable, e.g. by being scanned and/or rotated, according to any of the other described embodiments described herein. For example, the reflective component may be actuated by a jack 108 or reflective component gantry 112 as described above, or by any other actuating means.

The above technique is particularly useful for large-area VHGs. For example, when producing slanted VHGs with constant slant angle, the distance between a plane mirror and the glass substrate grows linearly with increasing VHG width, imposing an increasing demand on mechanical stability and geometric extent of the apparatus. Both these demands can be reduced when the reflective component itself has a slanted VHG whose effective slant angle is close to the desired slant angle of the desired VHG. The effective slant angle is the value of slant angle which the VHG behaves like after taking into account how the incident beam 22 is refracted at the surface of the film 15 via Snell's law (see equation 2). Further, using a slant mirror as reflective component reduces the required slope of the reflective component with respect to the photosensitive film 15, while maintaining flexibility to adjust the slant angle of the resultant VHG. The reflective component 25 does not need as large a range of rotational angles because it has an internal slant angle of the VHG. Furthermore, this arrangement simplifies the implementation of slant azimuthal angle control. This is because, the azimuth angle can be controlled by rotating the slanted VHG reflective component about an axis of the slant reflective component's normal direction. The physical space that needs to be allocated in a device to accommodate this rotation is less than the space needed to rotate an equivalently tilted conventional mirror.

Reflective components can include additional features for mitigating Fresnel reflections, which are a potential issue for any embodiment having a gap between the photosensitive film and the reflective component. In such embodiments, Fresnel reflections at the surface of the glass substrate can affect the interference pattern leading to errors in the resulting VHGs. To mitigate this, the surface of film support 94, especially the surface facing the reflective component 25, can have an anti-reflection coating for the respective range of incidence angles. To reduce Fresnel reflections at surface of photosensitive film 15 on which the incident beam 22 is incident, an index-matched covering layer with a suitable anti-reflection coating may be used. For the recording of low-angle slant VHGs, a movable baffle may be placed inside the enclosed chamber 104 to block the Fresnel reflection at the underside of the film support 94 from the reflected beam 28 as it returns from the reflective component 25.

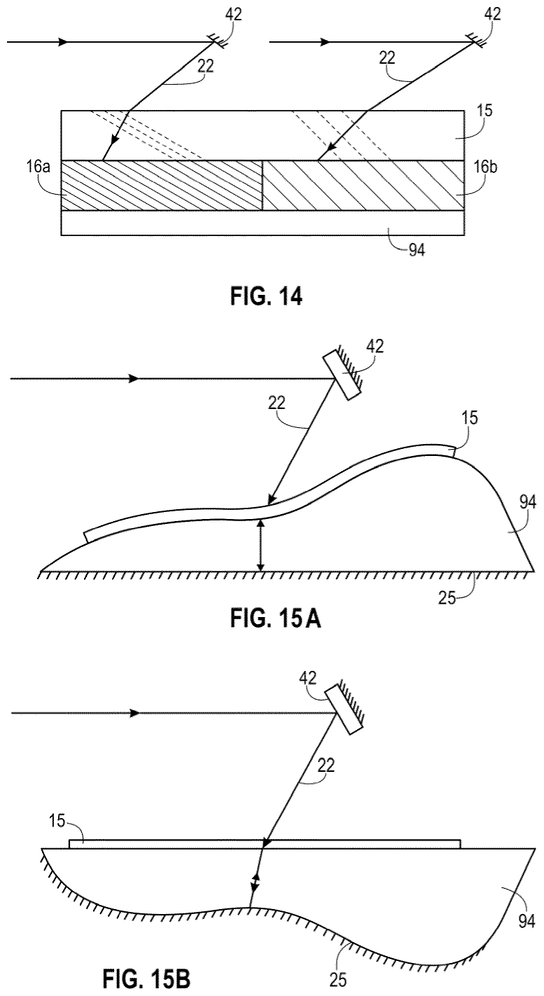

A further variation to embodiments having a reflective component comprising a VHG includes tiling smaller reflective components into a large reflective component. With reference to FIG. 14, a reflective component comprises a first tile 16a and a second tile 16b, each comprising a VHG. The first and second tiles are tiled, e.g. placed adjacently on a film support 94, and a photosensitive film 15 placed between the incident beam 22 and the tiles. The incident beam 22 irradiates the photosensitive film 15 according to the methods described below. In the regions of the photosensitive film 15 above each respective tile 16a, 16b, the VHG from each respective tile 16a, 16b is reproduced in photosensitive film 15. The dashed lines in FIG. 14 illustrate only part of the resultant VHGs for the sake of clarity. Since the first tile 16a has different VHG parameters, i.e. slant angle and/or spacing, to the second tile 16b, the regions above the first tile and second tile respectively also have different VHG parameters. Hence a spatially-varying VHG is produced in the photosensitive film 15. The scanning of the incident beam 22 across the photosensitive film 15 is controlled in order to produce the interference pattern between the incident beam 22 and the reflected beam 28 reflected off the reflective component tiles.

The above tiling technique provides a way to produce large-scale VHGs that may have spatially varying parameters (and VHGs with spatially varying parameters independent of size). This tiling technique can be used in combination with any of the methods described below and for any apparatus using a reflective component 25 which comprises two or more tiles 16a, 16b. In some examples, the photosensitive film 15 is placed directly on the reflective component tiles 16a, 16b, e.g. as illustrated in FIG. 14. In other examples, the photosensitive film 15 is separated from the reflective component tiles by a film support or an air gap, such illustrated in other figures.

In some examples rather than the first and second tiles 16a, 16b having different VHG parameters, they have the same slant angle and/or spacing. In these examples, smaller VHGs can be combined to produce a larger VHG with the same parameters, i.e. the VHG is multiplied in extent.

In some embodiments in which the reflective component 25 comprises tiles 16a, 16b, a diverging component as described above is used to smoothen the transition between regions above each respective file.

In another variation of the apparatus, the orientation of a plane of reflection of the reflective component is controlled by a film support. This can be done instead of or in addition to physically rotating the reflective component and can be combined with any of the apparatus arrangements described above.

With reference to FIGS. 15A and 15B, in some embodiments, the film support 94 has at least one surface which is not uniformly flat. In fact, there is a specific slope of the film support 94 which varies across locations of the photosensitive film. An example of this is shown in FIG. 15A, which is a side-view showing the varying slope in one direction. In general, however, the slope of the film support can vary in two-dimensions across its surface. The surface of the film support 94 opposite the surface of varying slope is reflective and acts as the reflective component 25. For example, this surface can be treated with a reflective coating.

Since the photosensitive film 15 sits on the film support 94, the slope of the film support controls the orientation of the reflective component with respect to the photosensitive film 15, i.e. by forming the slope of the photosensitive film 15. Varying the orientation of the photosensitive film 15 will result in the interference pattern between incidence and reflected beams being at an angle to the plane of the surface of the photosensitive film 15. Accordingly, the grating features will be at an angle to the plane of the surface of the photosensitive film 15 when it is removed from the film support 94. Hence an optical device is produced with a spatially-varying VHG, in particular, a spatially-varying slant angle. The scanning of the incident beam 22 across the photosensitive film 15 is performed in the same manner as other embodiments, except the angle of incidence of the incident beam 22 is controlled so that the reflection off the reflective component 25, preferably retro-reflection at normal incidence, will interfere with the incident beam 22. For example, the incident beam 22 is directed onto the photosensitive film 15 by a first mirror 42 of a scanning head 32 (not shown) controlled by a gantry system 40 (not shown). The incident beam 22 passes through the photosensitive film and is reflected off the reflective component 25 to form the reflected beam which interferes with the incident beam in the photosensitive film to produce the VHG.

In an alternative apparatus applying the same principle, with reference to FIG. 15B, the film support 94 has a flat surface to support the film 15 and instead the lower surface of the film support 94, which is the reflective component 25, has a variable slope. Hence the plane of reflection of the reflective component 25 varies across the film support 94 and accordingly the orientation of the plane of reflection of the reflective component is controlled by the slope of the film support 94 for each location of the photosensitive film 15. The scanning of the incident beam 22 is controlled in coordination with the slope of the film support 94 to ensure the interference pattern between the incident beam 22 and the reflected beam reflected off the reflective component 25 occurs in the photosensitive film 15.

The above arrangement having a varying slope film support 94 increase the precision and number of design options for producing a VHG having particular spatially-varying parameters.

### Methods for Making Spatially-Varying VHGs

Methods for using the above apparatus to produce spatially-varying VHGs are discussed below with reference to FIGS. 16-23.

With reference to FIG. 16, a method for making an optical device having a spatially-varying VHG comprises irradiating 140 a photosensitive film with a first beam of light from a light source. Suitable light sources include, lasers, optical parametric oscillators (OPOs), quasi-incoherent monochromatic light sources (e.g. below-threshold laser diodes), and any other light source capable of interference over a length scale of the thickness of the film. As an example, a minimum coherence threshold for the light source is a coherence length of 5 times the wavelength of light is enough for some applications. An example of a suitable photosensitive film is Covestro™ Bayfol™ film, or one of its derivatives.

In some exemplary methods, the first beam is optionally an incident beam and is reflected off a reflective component to form a reflected beam. The reflective component can be any of the forms described above. Alternatively, instead of an incident and reflected beam, two or more separate beams can be used and controlled to perform the methods herein. The fundamental condition is that the beams can produce an interference pattern together.

The method further comprises producing 142 a VHG in the photosensitive film 15 by producing an interference pattern between the first and second beams. With reference to the apparatus of FIG. 5A-C, when the photosensitive film 15 is arranged to coincide with (i.e. at least partially overlapping) the interference pattern 26 produced by the beams of light. At the location of intensity maxima 26a, the photosensitive film is irradiated with a sufficiently high dose of light to “expose” the film, that is to modify the refractive index, typically to increase the refractive index, in the region of the maxima. Typically, following exposure the photosensitive film will require to be “developed” by treating the film to give rise to the refractive index changes, and to make them permanent. This procedure is generally dependent on the specific photosensitive material used and is known for each specific material according to manufacturer's instructions. During the development process, the pattern of refractive index may be slightly altered in spacing and orientation. Typically, this change is reproducible for constant process parameters. Some films may not need developing. The VHG is described by the parameters discussed above, namely spacing and slant angle.

The method further comprises moving 144 the first beam and the second beam or the photosensitive material (photosensitive film 15) relative to the other. Hence, in contrast to conventional holography which is achieved using an expanded beam in a static set up, the incident beam 22 is scanned across locations on the photosensitive film 1 and the underlying plane mirror to create a VHG over a larger area of the photosensitive film 15. This increases the scalability for the methods for producing VHGs, without requiring a more powerful laser or larger optical lens to expand the beam and area of superposition between the two beams as needed for the static set up. When the first beam and second beams are incident and reflected beams, respectively, moving the first beam relative to the photosensitive material will also move the reflected beam with respect to the photosensitive material.

Moving 144 the first and second beams relative to the photosensitive film can be performed by scanning apparatus, as described above with reference to FIG. 6, and according to the process described as follows.

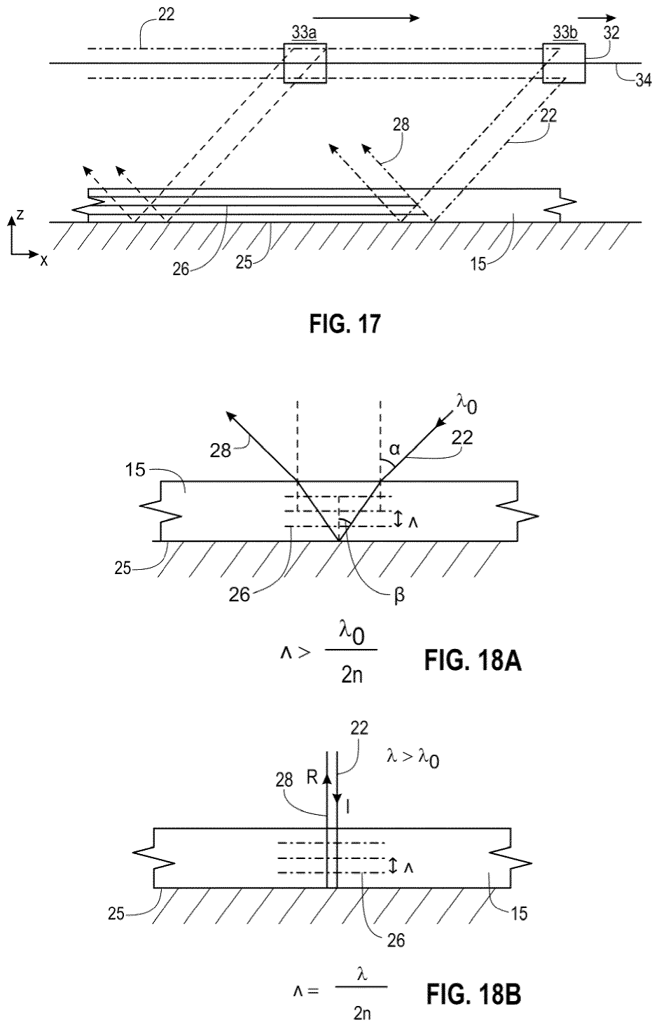

With reference to FIG. 17, a scanning head 32 scans across the photosensitive film 15 while receiving the incident beam 22 from a source (not shown) and directing the incident beam onto the photosensitive film 15. Further, the scanning head 32 controls the angle at which the incident beam 22 is directed onto the photosensitive film 15. The scanning head 32 is scanned in the directions shown by the arrow in FIG. 17 along a rail 34. For example, the scanning head 32 in a first position 33a directs the incident beam 22 onto the photosensitive film 15 in first region to creating a VHG in the first region. The scanning head 32 then moves along the rail 34 to a second position 33b where the scanning head 32 directs the incident beam 22 onto the photosensitive film 15 in a second region to create a VHG in the second region.

The method further comprises varying 146 one or both of the spacing and the slant angle of the VHG across locations of the photosensitive film. This is done by modifying the interference pattern spacing and/or the orientation of the photosensitive film with respect to the interference pattern.

A desired spacing of a VHG is typically achieved by controlling the relative angle between the first and second beams. The relative angle of the beams, along with the wavelength of the beams, determines the spacing of the maxima of the resulting interference pattern. Controlling the relative angle between first and second beams can be done in various ways. For example, with reference to FIGS. 18A and 18B, for apparatus having a mirror placed under the photosensitive film to reflect the incident beam, controlling the angle of incidence of the incident beam 22 determines the angle between incident and reflected beams. For example, a laser beam with wavelength of λ0 incident at zero degrees would create a VHG with Λ=Λ0/2n. This VHG would reflect or block light of wavelength λ0 at an angle of incidence approximately zero degrees. To create a VHG that blocks λ0 at a steeper angle, a VHG with a spacing Λ>λ₀/2n is required. A VHG with greater spacing can be created either by using the same monochromatic light at steeper angle, as illustrated in FIG. 18A, or different monochromatic light with a wavelength λ>λ0 at a smaller angle as illustrated in FIG. 18B.

With reference to FIGS. 18A and 18B, in some embodiments, the film 15 is placed next to a reflective component 25, such as a plane mirror, and the incident beam 22 impinges on the photosensitive film 15 at an angle of incidence in air α. The incident beam is refracted at the surface of the photosensitive film 15 and is incident on the plane mirror at an angle β (not shown) determined by Snell's law (equation 2). The incident beam 22 is reflected off the plane mirror to form the reflected beam 28, which then interferes with the incident beam in the photosensitive film 15 before leaving the photosensitive film. Although FIG. 18A shows only a ray representation of the incident and reflected beams 22, 28, the beams have a beam width such that the beams overlap to produce an interference pattern 26. The spacing between maxima of the interference pattern in this arrangement is given by:

$$Λ = \frac{{λ}_{0}}{2 n {cos β}_{i}} \qquad ( 6 )$$

wherein Λ is the spacing; λ0 is the wavelength of the incident beam in the medium of the photosensitive film 15; and βᵢ is the angle of incidence in the medium (related to a by Snell's law). Hence the spacing of the interference pattern, and consequently the spacing of the VHG produced in the photosensitive film is determined by the wavelength of the incident beam and the angle of incidence α. It will be appreciated that the same relationship holds whether the film 15 is in contact with the plane mirror 15 or spaced from it, as described above with reference to FIGS. 5A and 5B.

In other embodiments, as illustrated in FIG. 18B, the incident beam 22 is normal to the surface of the film 15 (i.e. angle of incidence is 90 degrees). At normal incidence, the expression for the spacing simplifies to Λ=λ/2n. To achieve the desired spacing Λ, the wavelength in the film 15 of the incident beam 22 increased from λ0 to λ. This can be done using a tunable light source, such as a tunable laser. Controlling the wavelength of the light beams to control the spacing of the VHG is not limited to conformal VHGs, as shown in FIG. 18, but also applies to methods for producing slant VHG, which are discussed further below.

Using apparatus for producing slant VHGs, the slant angle can be varied by controlling the orientation of the interference pattern with respect to the photosensitive material. In methods which reflect the incident beam off a reflective component to form a reflected beam, the orientation of the interference pattern can be controlled by the orientation of a plane of reflection of the reflective component.

Using the apparatus described with reference to FIG. 8, the first mirror 42 and reflective component 25 are arranged with respect to the photosensitive film 15 such that the following process for varying the slant angle of the VHG in the photosensitive film 15 can be performed. With the photosensitive film 15 static, changing the orientation of the reflective component 25, specifically the normal to the plane of reflection of the reflection component, will change the slant angle of the resulting VHG. In order to ensure that the incident beam 22 and the reflected beam 28 reflected off the reflective component 25 overlap in the photosensitive film 15 (and therefore can produce an interference pattern) the first mirror 42 directs the beam so that the incident beam 22 is retro-reflected to form the reflected beam 28. In this case, the incident and reflected beams will be parallel and counter-propagating and hence overlap in the photosensitive film 15. Hence the two beams produce an interference pattern to create a VHG in the photosensitive film 15. In other examples, the incident beam 22 does not need to be retroflected off the reflective component, provided that the incident and reflected beams overlap in the photosensitive film. This may be the case if the distance between the photosensitive film 15 and the reflective component 25 is small enough, or that the incident beam 22 width is large enough, so that the angle between the incident and reflected beams does not diverge the beams so much that there is no overlap in the photosensitive film 15.

During the process of producing a slant VHG in the photosensitive film 15, the incident beam 22 is scanned across the photosensitive film 15, e.g. by a scanning head (e.g. as described with reference to FIG. 7). During the scan the first mirror 42, the angle of the first mirror 42 and the reflective component 25 are rotated in coordination in order to maintain and interference pattern in the photosensitive film 15. This controls the orientation of the interference pattern and hence the corresponding slant angle produced. In this way, the apparatus as shown schematically in FIG. 8 produces a VHG having a spatially-varying slant angle.

The principles outlined above with reference to FIG. 8 apply to any of the apparatus for producing slant angle VHGs as described herein. For example, each type of reflective component and reflective component actuating means can be used to control the slant angle in the VHG by controlling the orientation of the reflective component plane of reflection. For example, for apparatus having a slant mirror as the reflective component such as described with reference to FIG. 13, the reflective component 25 can be rotated or translated in any direction which changes the plane of reflection at the location where the incident beam is reflected. This includes rotating the reflective component about an axis normal to its surface, e.g. to control the azimuthal slant angle.

Another way to vary the slant angle of a VHG is by using a technique to ‘copy’ an existing spatially-varying VHG. In this method, the moving 144 of the incident beam relative to the photosensitive film is done in coordination with controlling the angle of incidence of the first beam so that the incident beam is retro-reflected at the underlying VHG at each location during the scan. The wavelength of the incident beam should also be chosen to match the wavelength which the underlying VHG reflects. The interference pattern produced by the incident and reflected beams correspond to the slant angle and spacing of the underlying VHG and hence the newly produced VHG will be a copy of the underlying VHG.

Using the above copying effect, a method for copying a VHG includes placing a photosensitive film 15 on a device comprising a master VHG and irradiating the photosensitive film with an incident beam 22 such that a VHG is produced in the photosensitive film having the same slant angle and/or spacing as the master VHG. In some embodiments, the irradiating beam 22 is scanned across the photosensitive film 15 and the angle of incidence and/or wavelength of the incident beam is controlled in coordination with the parameters of master VHG at each location to produce a copy VHG of the master VHG in the photosensitive film. In embodiments where the master VHG has spatially-varying parameters of slant angle and/or spacing, the copy VHG will also have these spatially-varying parameters. Furthermore, in examples as described in further detail above with reference to FIG. 14, a photosensitive film 15 is placed over two or more tiles comprising respective VHGs in order to combine smaller sized VHGs into a single larger VHG. In some such embodiments, smoothening of the borders of slant patches or tiles is provided.

After producing a spatially-varying VHG according to the above methods, any slant VHG in a photosensitive film layer may be combined with any other slant or conformal VHG layers, birefringent layers, etc. in a stack to form a composite filter.

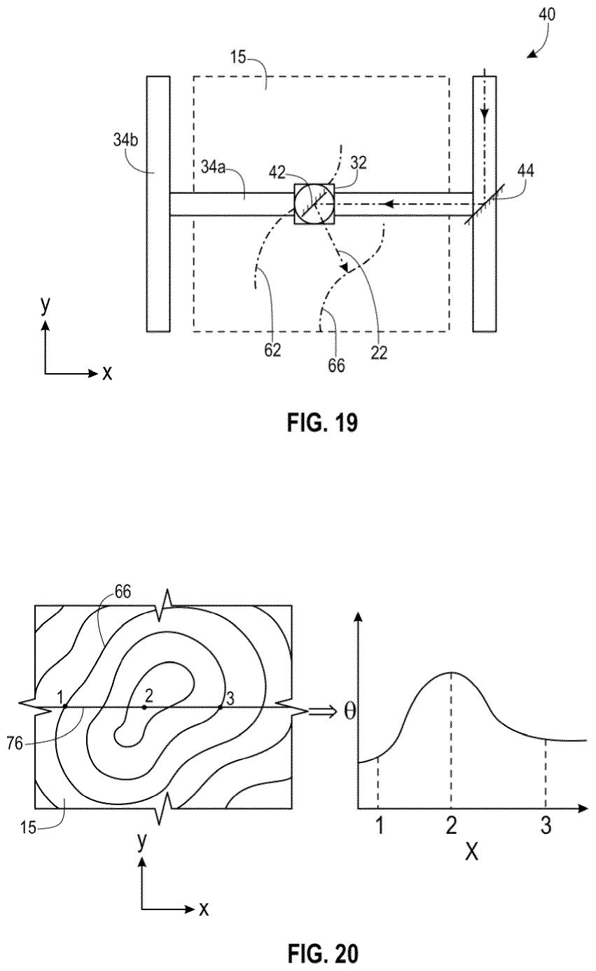

Further techniques for improving the performance of scanning the incident beam over the photosensitive film are described below with reference to FIG. 19-23.

With reference to FIG. 19, a gantry scanning system 40 of the type described in reference to FIG. 6 can be controlled to follow particular contours of a VHG map as described with reference to FIG. 3. The process comprises controlling the scanning head 32 to travel along a scanning head path 62 so that the incident beam 22 scans across locations on a contour of the VHG map. The scanning head fixes the input parameters to record a VHG along the contour having the particular value associated with the contour. For example, the angle of incidence can be controlled to be a fixed value by setting the rotational position of the first mirror 42 of the scanning head. The fixed angle of incidence will determine the angle of light that the resulting VHG will block or reflect. The scanning head 32 travels such that the incident beam 22 scans locations on the contour. In this case, no rotation of the first mirror 42 is required since the contour indicates locations having the same required angle of incidence. Following production of part of a VHG at locations along the contour, a second contour is selected. The first mirror 42 of the scanning head 32 is then set to the new required rotational position for the second contour, and then the beam is scanned across locations of the second contour. This can be repeated until the whole photosensitive film 15 has been scanned by the incident beam 22 to produce the VHG across the photosensitive film 15.

With reference to FIG. 20 to 22, an alternative approach to producing the desired VHG map in a photosensitive film 15 is to choose a scan path and determine the required VHG parameters required at each location along the path. For example, if the photosensitive film is to be scanned in a series of rows, the VHG map will describe the varying values of the VHG parameter across a particular row. For example, a scan path along a row between points 1-2-3 produces a graph of blocking angle as a function of position along this row, as illustrated in FIG. 20. The value of the graph at each location along the row represents the blocking angle at each location according to the VHG map. The value of the variable parameter at each point on the scan path then determines what the angle of incidence (and/or wavelength) of the incident beam 22 should be at that point. Hence the VHG described by the VHG map is produced with the desired values at each location.

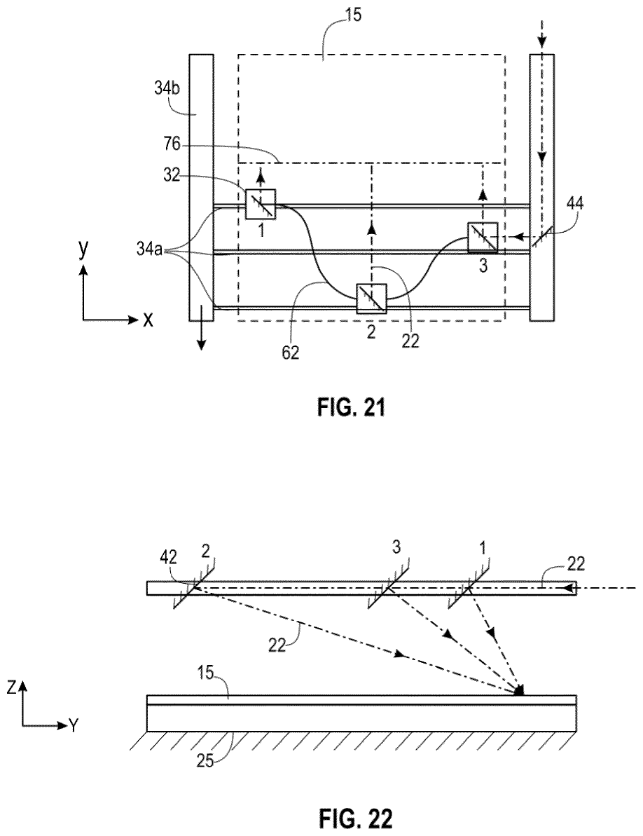

With reference to FIG. 21, as the incident beam 22 is scanned along scan path 76, the scanning head 22 is controlled to vary the angle of incidence of the incident beam 22 so that the required angle is set at each location along the scan path 76 in order to create the desired VHG as described by the VHG map. With reference to FIG. 22, in some embodiments, the angle of incidence of the incident beam 22 affects the location of incidence. For example, at a location 1 having a low angle of incidence (nearer to normal incidence) the location of incidence is closer to directly below the scanning head 32, whereas for a large angle of incidence, at location 2, the location of incidence is cast further from directly below the scanning head. Accordingly, to maintain a scan 76 in a straight line but having different angles of incident along the scan path 76, the scanning head should be controlled in a direction perpendicular to the scan direction to offset the change in location of incidence what would be caused by the changing angle of incidence. For example, when the VHG requires a smaller blocking angle at a point along the scan path 76, such as at points 1 or 3, the scanning head 32 and scanning head path 62 will be closer to the scan path 76 in the y-direction. When the VHG along the scan path 76 requires a larger blocking angle (i.e. closer towards grazing incidence), such as at point 2, the scanning head 32 and scanning head path 62 will be farther from the scan path 76 in the y-direction. In either case, the angle of incidence will also be controlled, e.g. by the first mirror 42 or gimbal 52 as described in reference to FIG. 7, to create a VHG at that position along the scan path 76 with the appropriate spacing and/or slant angle to produce the desired blocking angle at that position.

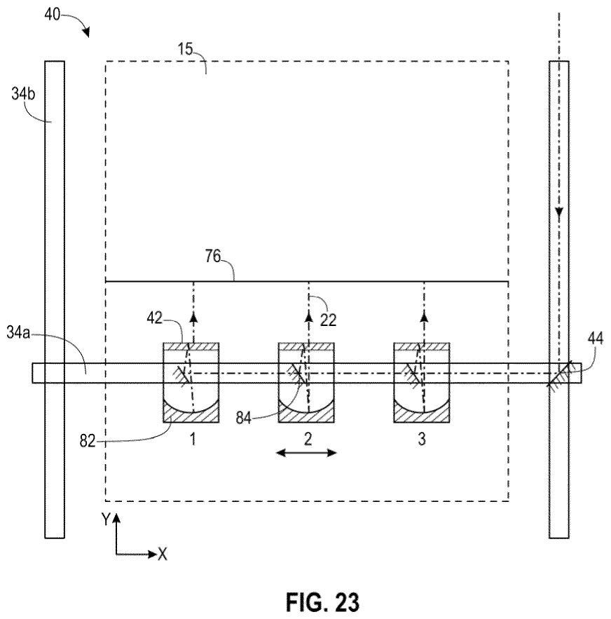

With reference to FIG. 23, a scanning head 32 as described with reference to FIG. 7D is used to avoid offsetting the scanning head position during scan to account for changing angle of incidence. Having a mirror assembly 80 with a first mirror 42 and second, elliptical, mirror 82 means that the changing angle of incidence does not change the location of incidence of the incident beam 22. Instead, the incident beam 22 always impinges the photosensitive film 15 at the second focal point B. Using this approach, to record a VHG in a photosensitive film across a straight scan path 76 requiring different angles of incidence, the scanning head path scan also be a straight path. This avoids the need to move the position of the first rail 34a along the second rails 34b during scanning of a single row.

Any of the above techniques for controlling the scan path described with reference to FIG. 19 to 23 can be combined with any of the methods/apparatus described herein for producing VHGs. For example, these techniques are suitable for producing both conformal or slanted VHGs, with any of the types of scanning systems.

In addition to, or instead of, the above techniques for controlling the scan path, other parameters of the scan can be controlled. For example, either the power of the light source, such as a laser, or the speed of the scan across the photosensitive film can be varied to ensure even exposure of the photosensitive film. Since scanned VHG production typically involves continuous acceleration and deceleration of the scanning head 32, to avoid overexposure of the photosensitive film at the turning points of the scanning head path 62, the power of the incident beam 22 is dynamically adjusted. That is, when the scanning head 32 scans at a lower speed (e.g. decelerating before changing direction) the power of the laser source may be decreased so that the areas over which the incident beam 22 passes more slowly are not overexposed. In other words, the incident beam 22 is scanned in order to maintain substantially constant amount of energy (which is power integrated over time) per unit area across locations swept by the incident beam (which can be defined as beam width multiplied by distance scanned). This approach allows for more compact scanning areas, since faster changes of direction are possible, and a reduced amount of overexposed material which cannot be used. It also allows use of photosensitive films with variable-exposure requirements, since the exposure can be tailored. It also allows for side-by-side recording of smaller-area VHGs in a large sheet in a continuous scan.

Conversely, if it is preferable to maintain a steady power level in the source of the incident beam 22, the speed of the scanning head 32 can be controlled using the same principles to maintain substantially constant amount of energy per unit area across locations swept by the incident beam. In general, a combination of adjusting the power and scan speed can be used together to produce the desired effect.

Another technique for controlling the exposure level in the photosensitive film is to increase the power of the incident beam 22 when the angle of incidence increases, i.e. when the spot size of the incident beam 22 increases. Since having a specific level of power spread over a larger spot size would reduce the intensity and may result in underexposure, increasing the power to maintain a desired intensity will counteract this. The result is a more reliable method of producing a VHG in a photosensitive film.

To adjust the incident beam power synchronously with the scanning motion, an acousto-optical modulator (AOM) or an acousto-optical tunable filter (AOTF) offers the suitable bandwidth and extinction ratio. In addition, AOTFs allow for the multiplexing of multiple recording wavelengths at arbitrary power ratios and is therefore well suited for an industrial laser setup for recipe-based scanned filter production. Other implementations using optomechanical elements and mechanical adjustment of variable attenuators offer the same general functionality at a lower resolution and bandwidth.

For some embodiments where the variation of blocking angle across the filter is large, it is necessary to switch recording laser within one recording session. This would cause a visible, sharp and distracting transition between the two. To avoid this, an AOTF in conjunction with variable angle control can blend the two regions gradually to smoothen the transition.

In combination with or independently from any of the above methods, the wavelength of the incident beam 22 can be controlled to change during VHG production, so that the period of the interference pattern produced by the incident beam 22 and the reflected beam (e.g. reflection off a reflective component) changes. This in turn changes the spacing the resulting VHG, and hence acts as an additional degree of control to create the precisely desired VHG. For example, this can be achieved sequentially by known tunable-wavelength lasers, or by switching between two lasers as described above using an AOTF.

Any of the above techniques for controlling the production of VHGs can be combined with any method described herein for scanning an incident beam 22 across the film 15. Likewise, all of the techniques described above regarding scanning and controlling the angle of incidence, power, scan path, wavelength etc. are applicable to any apparatus disclosed herein. In particular, these processes apply to both producing conformal VHGs (zero-degree slant angle) and slanted VHGs, since both use scanning and controlling properties of the incident beam.

### System for Producing VHGs

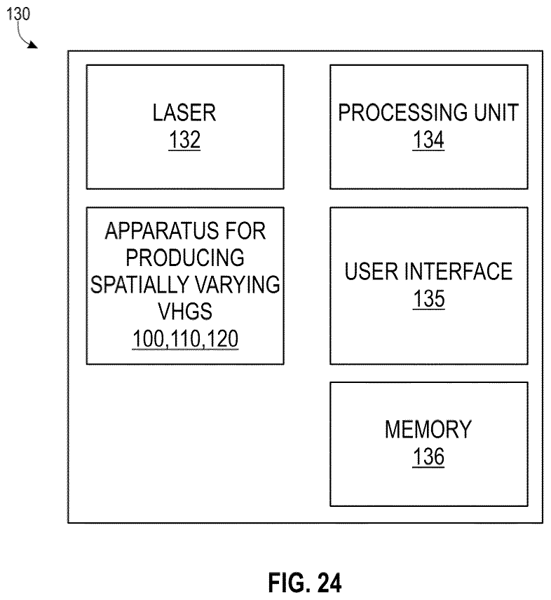

With reference to FIG. 24, a system 130 for producing spatially-varying VHGs includes a laser 132; apparatus for producing spatially-varying VHGs 100, 110, 120 as described above in detail with reference to the figures; a processing unit 134; a memory 135 and a user interface 136. The apparatus for producing spatially varying VHGs uses the output of the laser 132 to produce a VHG in a photosensitive film 15 positioned in the apparatus. The processing unit 138 controls the settings and function of the laser 132, e.g. on/off setting, power level, wavelength tuning and, where there are multiple lasers, the settings for each in addition to control of an AOTF for combining the outputs of the multiple lasers. The processing unit 134 controls the settings of the apparatus for producing spatially-varying VHGs. This includes control over the positioning of any moving parts of the apparatus such as a gantry for controlling the position and scan path of the scanning head 32, reflective component 25 and/or the photosensitive film 15; and likewise the orientation of the components such as setting the rotational angle of the scanning head and/or reflective component etc. The processing unit controls each of these, or any subset thereof, to perform steps of a method for producing a spatially-varying VHG. This includes coordinating the components of the apparatus using actuating means, along with the output of the laser 132 according to produce an optical device with the desired VHG. The required parameters of the desired VHG can be input via a user interface 135 from a user or stored in a memory 136 and recalled when a new VHG is produced.

1-52. (canceled)

53. A method for making an optical device having a spatially-varying volume holographic grating, the method comprising:
irradiating a photosensitive material with a first beam of light;
producing a volume holographic grating in the photosensitive material by producing an interference pattern in the photosensitive material due to interference of the first beam with a second beam of light, wherein the volume holographic grating comprises periodic grating features spaced along a grating direction by a spacing and the grating direction forms a slant angle with respect to a surface of the photosensitive material;
moving the first beam and the second beam or the photosensitive material relative to the other to scan the first beam and the second beam across locations on the photosensitive material; and
varying one or both of the spacing and the slant angle of the volume holographic grating across locations on the photosensitive material.

54. The method of claim 53, wherein the spacing and/or the slant angle of the volume holographic grating varies gradually across locations on the photosensitive material.

55. The method of claim 53, the method comprising reflecting the first beam after it passes through the photosensitive material to form the second beam.

56. The method of claim 53, the method comprising changing, across locations on the photosensitive material, at least one of:
a wavelength of the first beam and/or a wavelength of the second beam; and/or
an angle of incidence beam onto the photosensitive material of the first beam and/or the second beam.

57. The method of claim 53, wherein the spacing of the volume holographic grating varies across locations of the photosensitive material.

58. The method of claim 57, wherein the spacing of the volume holographic grating is varied by changing a wavelength of the first beam.

59. The method of claim 57, wherein the spacing of the volume holographic grating is varied by changing the relative angle between the first beam and the second beam across locations on the photosensitive material.

60. The method of claim 53, wherein the slant angle of the volume holographic grating varies across locations of the photosensitive material.

61. The method of claim 60, wherein an azimuthal slant angle of the slant angle varies across locations of the photosensitive material.

62. The method of claim 60, wherein the slant angle is varied by controlling the orientation of the interference pattern with respect to the photosensitive material.

63. The method of claim 62, wherein the reflective component is formed from tiles of reflective components, prior to scanning, by placing tiles next to each other.

64. The method of claim 53, further comprising passing the first beam through a beam-diverging component to increase the divergence of the first beam before the first beam is incident of the photosensitive material.

65. The method of claim 53, the method including adjusting the power of the first beam when the angle of incidence is changed to maintain a substantially constant intensity incident on the photosensitive material per unit area of the photosensitive material.

66. The method of claim 53, the method including adjusting a scan path of the first beam when the angle of incidence changes to offset a change in location of incidence of the first beam caused by the change in angle of incidence and/or to maintain a substantially constant amount of energy per unit area across locations swept by the incident beam despite a change in size of the first beam.

67. The method of claim 53, the method including adjusting the power of the first beam and/or a scan speed with which the first beam is scanned in order to maintain a substantially constant amount of energy per unit area across locations swept by the first beam.

68. An optical device comprising a spatially-varying volume holographic grating, wherein the volume holographic grating comprises periodic grating features spaced along a grating direction by a spacing and the grating direction forms a slant angle with respect to a surface of the photosensitive material, wherein one or both of the spacing and the slant angle of the volume holographic grating vary across locations on the optical device.

69. The optical device of claim 68, wherein the spacing and/or the slant angle of the volume holographic grating varies gradually across locations on the optical device.

70. The optical device of claim 68, wherein the spacing and/or the slant angle of the volume holographic grating vary in two dimensions across a plane of the optical device.

71. An apparatus for making a spatially-varying volume holographic grating in a photosensitive material, the apparatus comprising:
a support arranged to dispose a photosensitive material;
a beam producing system comprising one or more light sources, wherein the beam producing system is arranged to produce a first beam of light and a second beam of light to produce a volume holographic grating in the photosensitive material, wherein the volume holographic grating comprises periodic grating features spaced along a grating direction by a spacing and the grating direction forms a slant angle with respect to a surface of the photosensitive material;
a gantry system arranged to scan the first beam and the second beam across locations on the photosensitive material; and
a controller arranged to:
control the gantry system to scan the first and second beams across locations on the photosensitive material; and
control the light source and/or the gantry system to vary one or more parameters of the first beam and the second beam to vary one or both of the spacing and the slant angle of the volume holographic grating across locations on the photosensitive material.

72. A system for producing an optical device comprising a spatially-varying volume holographic grating in a photosensitive material, the system comprising:
the apparatus according to claim 71;
a processing unit for instructing the controller to control the spacing and the slant angle of the volume holographic grating across locations on the photosensitive material.
